(19) United States
(12) Patent Application Publication
(10) Pub. No.: US 2026/0264025 A1
(43) Pub. Date: Sep. 10, 2026

(54) MIL-125-NH2 METAL ORGANIC FRAMEWORK NANOCOMPOSITE MEMBRANE FOR TREATING OILY WASTEWATER AND A METHOD OF PREPARATION THEREOF

(71) Applicant: KING FAHD UNIVERSITY OF PETROLEUM AND MINERALS, Dhahran (SA)

(72) Inventors: Umair BAIG, Dhahran (SA); Abdul WAHEED, Dhahran (SA); Isam H. ALJUNDI, Dhahran (SA)

(73) Assignee: KING FAHD UNIVERSITY OF PETROLEUM AND MINERALS, Dhahran (SA)

(21) Appl. No.: 19/072,926

(22) Filed: Mar. 6, 2025

(51) Int. Cl. B01D 69/14; B01D 67/00; B01D 69/02; B01D 69/12; C02F 1/44; C02F 101/32

(52) U.S. Cl. CPC B01D 69/148; B01D 67/0006; B01D 67/0079; B01D 67/0093; B01D 67/0095; B01D 69/02; B01D 69/1214; B01D 69/1411; C02F 1/44; B01D 2253/204; B01D 2315/10; B01D 2323/081; B01D 2323/12; B01D 2323/14; B01D 2323/30; B01D 2325/02834; B01D 2325/04; B01D 2325/12; B01D 2325/36; C02F 2101/325; C02F 2209/03; C02F 2305/04

(57) ABSTRACT

A membrane for oil separation includes a first layer including a ceramic alumina support, and a second layer including particles of a MIL-125-NH₂ metal-organic framework (MOF) crosslinked with isophthaloyl units. One or more amine groups of the MIL-125-NH₂ MOF are covalently bonded to one or more acid groups of the IPC. The membrane is porous with a pore size of 0.01 to 0.2 micrometers (μm). The particles of the second layer are in the shape of discs having the longest dimension of 0.5 to 3 μm.

### STATEMENT REGARDING PRIOR DISCLOSURE BY THE INVENTORS

Aspects of the present disclosure are described in Baig, U. et al., “Tailored alumina nanocomposite membranes featuring MIL-125-NH₂ metal-organic frameworks for oily wastewater treatment” published in Volume 7, npj Clean Water (2024), which is incorporated herein by reference in its entirety.

### STATEMENT OF ACKNOWLEDGEMENT

Support provided by the Interdisciplinary Research Center of Membranes and Water Security, King Fahd University of Petroleum and Minerals, Saudi Arabia, through Project INMW2406 is gratefully acknowledged.

### BACKGROUND

### Technical Field

The present disclosure is directed towards a MIL-125-NH₂ metal organic framework (MOF) nanocomposite membrane, and more particularly, towards a MIL-125-NH₂ metal organic framework (MOF) nanocomposite membrane for water treatment techniques for treating oily wastewater.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

As industrialization has progressed, pollution has expanded across various sectors, with rising water pollution as a concern. Domestic waste, industrial effluents, and oil leaks deteriorate water quality in lakes, rivers, and seas, while marine oil spills and oily wastewater discharges from industries restrict access to clean water for large populations. Marine oil spills and oily wastewater discharges from industries cause ecological damage and pose risks to marine ecosystems and human health. Oily wastewater, often in the form of oil-in-water emulsions or immiscible oil-water mixtures, pose environmental and health threats [Zhou, Q. et al., Geological evolution of offshore pollution and its long-term potential impacts on marine ecosystems, Geosci. Front., 2022, 13, 101427]. Sustainable industrial development demands scientific, environmental, and economic initiatives to mitigate pollution from oil production and address oil spill accidents through efficient oil removal strategies.

Oily wastewater has traditionally been treated using methods like adsorption, flotation, coagulation, and biological processes [Abuhasel, K. et al., Oilywastewater treatment: Overview of conventional and modern methods, challenges, and future opportunities, Water, 2021, 13, 980]; however, these techniques face drawbacks such as low efficiency, high costs, energy consumption, and secondary waste generation. Development of advanced membrane technologies address these issues, offering advantages like hydrophilicity, mechanical strength, and chemical stability to make them more effective and sustainable for large-scale industrial applications [Jiang, D. et al., Customized copper/cobalt-rich ferrite spinel-based construction ceramic membrane incorporating gold tailings for enhanced treatment of industrial oily emulsion wastewater, Sep. Purif. Technol., 2023, 320, 124131]. Efforts have increasingly focused on enhancing membrane performance by developing advanced materials and/or modifying conventional membranes. While membranes offer high separation efficiency and low energy requirements, they face challenges such as fouling, limited chemical resistance, and high production costs. To overcome these challenges, techniques like surface modifications for antifouling, incorporation of nanomaterials for stability, and hybrid membrane development have been explored. These advancements aim to extend membrane lifespan and improve efficiency in treating oily wastewater.

Oil-in-water (O/W) separation efficiency depends on membrane fouling, where unwanted substances such as oil, particles, and/or organics accumulate on the membrane surface or within its pores. Hydrophilic membranes may be preferred for O/W emulsion separation due to their affinity for water [An, Y. P. et al., Janus membranes with charged carbon nanotube coatings for deemulsification and separation of oil-in-water emulsions, ACS Appl. Mater. Interfaces, 2018, 10, 9832-9840]. Advanced polymer membranes for effective oil-water separation, with performance indicators such as permeability and fouling resistance identifying reliable and cost-effective options, have been developed. These polymer membranes exhibit resistance to aging, ensuring durability, and sustained performance in wastewater treatment applications [Zhang, J. et al., A comprehensive review on the behavior and evolution of oil droplets during oil/water separation by membranes, Adv. Colloid Interface Sci., 2023, 319, 102971]. Surface modification of membranes has garnered attention in the pursuit of developing hydrophilic surfaces with oleophobic properties for enhancement of oil-water separation techniques.

To improve separation efficiency, integration of metal-organic frameworks (MOFs) into membrane technologies has emerged. Choice of metal and linker influences the structure and performance of MOFs, making them versatile for a wide range of applications [Cheng, Y. et al., Advances in metal-organic framework-based membranes, Chem. Soc. Rev., 2022, 51, 8300-8350]; however, integration of MOFs into hybrid membranes for oil-water separation still faces challenges, including high fabrication costs, complex processes, and the need for stable, defect-free MOF layers that can withstand fouling and degradation during long-term use. Developing a stable and continuous MOFs active layer supported by a ceramic microfiltration support that can be effectively applied in a crossflow filtration set-up may be used for oily wastewater treatment. Given the high utility and versatility of interfacial polymerization in membrane fabrication, interfacial polymerization may be readily applied to generate a stable and defect-free active layer on a support. Interfacial polymerization is a well-established technique that has been widely used on the industrial scale. During interfacial polymerization, an active layer is generally grown using an aqueous amine and non-aqueous acid chloride on an ultrafiltration/microfiltration support. Interfacial polymerization has shown positive effects for integration of MOFs as fillers in thin film nanocomposite (TFN), nanofiltration (NF), reverse osmosis (RO), and forward osmosis (FO) membranes [Wang, Y. et al., Construction of high performance thin-film nanocomposite nanofiltration membrane by incorporation of hydrophobic MOF-derived nanocages, Appl. Surf. Sci., 2021, 570, 151093; and Lee, J. Y. et al., Metal-organic framework-based porous matrix membranes for improving mass transfer in forward osmosis membranes, J. Memb. Sci., 2015, 492, 392-399]. Advancements are need for the development of stable, long-lasting MOF-based membranes with improved fouling resistance, chemical stability, and scalability for large-scale industrial applications for oily wastewater treatment.

Accordingly, an object of the present disclosure is to provide a membrane for treating oily wastewater that may circumvent drawbacks and limitations, such as high costs, complex fabrication processes, poor fouling resistance, low thermal stability, chemical degradation, and limited scalability, of the methods and materials known in the art.

### SUMMARY

In an exemplary embodiment, a membrane is described. The membrane includes a first layer including a ceramic alumina support and a second layer including particles of a MIL-125-NH₂ metal-organic framework (MOF) crosslinked with isophthaloyl units. One or more amine groups of the MIL-125-NH₂ MOF is covalently bonded to one or more acid groups of the isophthaloyl units. The membrane is porous with a pore size of 0.01 to 0.2 micrometers (μm). The particles of the second layer are in the shape of discs having a longest dimension of 0.5 to 3 μm.

In some embodiments, the membrane has a water in air contact angle of 0 degrees (°).

In some embodiments, the membrane has an oil in air contact angle of 0°.

In some embodiments, the membrane has an oil in water contact angle of 155 to 165°.

In some embodiments, the MIL-125-NH₂ MOF has an average particle size of 0.5 to 0.9 μm.

In some embodiments, the MIL-125-NH₂ MOF has a Brunauer-Emmett-Teller (BET) surface area of 900 to 1000 square meter per gram (m²/g).

In some embodiments, the MIL-125-NH₂ MOF is porous and has a micropore surface area of 700 to 750 m²/g and a micropore volume of 0.25 to 0.3 cubic centimeters per gram (cm³/g).

In some embodiments, the MIL-125-NH₂ MOF is porous and has a pore width of 0.88 to 0.9 nanometers (nm) and an average pore diameter of 1.5 to 2 nm.

In some embodiments, covalent bonds between the one or more amine groups of the MIL-125-NH₂ MOF and the one or more acid groups of the isophthaloyl units are formed through interfacial polymerization.

In some embodiments, the particles in the second layer are stacked and agglomerated having an average stacked height of 0.2 to 4 μm.

In some embodiments, the membrane has a water permeability of distilled water of 500 to 1400 liters per square meter per hour per bar (L m⁻² h⁻¹ bar⁻¹) at a pressure of 1 bar.

In some embodiments, the membrane has a water permeability from an oil-in-water emulsion of 300 to 500 L m⁻² h⁻¹ bar⁻¹ at a pressure of 1 bar.

In some embodiments, the membrane has a bulk porosity of 20 to 30% based on a volume of voids in the membrane over the total volume of the membrane.

In another embodiment, a method of oil separation is described. The method includes contacting the membrane with an oily mixture including one or more oils and water and collecting a filtrate. The filtrate includes a lesser amount of the one or more oils in comparison to the amount of the one or more oils in the oily mixture.

In some embodiments, the membrane has a separation efficiency of at least 98% based on an initial amount of the one or more oils in the oily mixture.

In some embodiments, the membrane includes applying a transmembrane pressure of 0.1 to 3 bar after the contacting.

In some embodiments, the oily mixture includes a surfactant.

In some embodiments, the method further includes cleaning the membrane, then repeating contacting the membrane with an oily mixture 2 times to 5 times and collecting a filtrate. The membrane has a separation efficiency of at least 98% of that of an initial separation efficiency.

In another embodiment, a method of making the membrane is described. The method includes mixing titanium isopropoxide and 2-aminoterephthalic acid in dimethylformamide and methanol to form a solution, heating the solution at a temperature of 130 to 170 degrees Celsius (° C.) for 20 to 28 hours (h) to form a solid, and calcinating the solid at a temperature of 180 to 220° C. for 4 to 8 h to form the MIL-125-NH₂ MOF. The method includes dispersing the MIL-125-NH₂ MOF in water to form a mixture, depositing the mixture on the ceramic alumina support, drying the mixture on the ceramic alumina support, dipping the dried mixture on the ceramic alumina support in an n-hexane solution of IPC to form a pre-membrane, and curing the pre-membrane at a temperature of 50 to 90° C. for 0.5 to 2 h to form the membrane.

In some embodiments, the membrane includes 30 to 120 milligrams (mg) of the MIL-125-NH₂ MOF in 100 milliliters (mL) of water.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary flow chart depicting a method of oil separation, according to certain embodiments.

FIG. 1B is an exemplary flow chart depicting a method of making a MIL-125-NH₂ metal organic framework (MOF) nanocomposite membrane, according to certain embodiments.

FIG. 1C depicts an exemplary schematic route for the synthesis of the MIL-125-NH₂ MOF using an amino-functionalized ligand, aminotris (hydroxymethyl) methane (ATPA), and titanium tetraisopropoxide (TTIP) via a solvothermal process, according to certain embodiments.

FIG. 1D depicts various stages in the fabrication of a MIL-125-NH₂ MOF decorated alumina ceramic membrane using an interfacial polymerization process, according to certain embodiments.

FIG. 2A is an X-ray diffraction (XRD) pattern of the MIL-125-NH₂ MOF at a 20 of 5 to 25 degrees (°), according to certain embodiments.

FIG. 2B is an XRD pattern of the MIL-125-NH₂ MOF at a 20 range of 5 to 70°, according to certain embodiments.

FIG. 2C is a Fourier-transform infrared (FTIR) spectrum of the MIL-125-NH₂ MOF, according to certain embodiments.

FIG. 2D is a scanning electron microscopy (SEM) image of the MIL-125-NH₂ MOF with a scale of 10 micrometers (μm), according to certain embodiments.

FIG. 2E is an SEM image of the MIL-125-NH₂ MOF with a scale of 5 μm, according to certain embodiments.

FIG. 2F is an SEM image of the MIL-125-NH₂ MOF with a scale of 1 μm, according to certain embodiments.

FIG. 2G is an energy-dispersive X-ray (EDX) spectra of the MIL-125-NH₂ MOF, according to certain embodiments.

FIG. 2H is an elemental mapping image depicting distribution of carbon (C) in the MIL-125-NH₂ MOF with a scale of 10 μm, according to certain embodiments.

FIG. 2I is an elemental mapping image depicting distribution of titanium (Ti) in the MIL-125-NH₂ MOF with a scale of 10 μm, according to certain embodiments.

FIG. 2J is an elemental mapping image depicting distribution of oxygen (O) in the MIL-125-NH₂ MOF with a scale of 10 μm, according to certain embodiments.

FIG. 2K is an elemental mapping image depicting distribution of nitrogen (N) in the MIL-125-NH₂ MOF with a scale of 10 μm, according to certain embodiments.

FIG. 3A is a nitrogen (N₂) adsorption-desorption isotherm of the MIL-125-NH₂ MOF, according to certain embodiments.

FIG. 3B is a pore size distribution curve of the MIL-125-NH₂ MOF, according to certain embodiments.

FIG. 3C is a three-dimensional (3D) structural model of the MIL-125-NH₂ MOF, according to certain embodiments.

FIG. 3D is a 3D structural model of the MIL-125-NH₂ MOF along a c-plane, according to certain embodiments.

FIG. 3E is a 3D structural model of the MIL-125-NH₂ MOF along a b-plane, according to certain embodiments.

FIG. 3F is a 3D structural model of the MIL-125-NH₂ MOF along an a-plane, according to certain embodiments.

FIG. 4A is a schematic representation of an interfacial polymerization reaction between the MIL-125-NH₂ MOF and isophthaloyl chloride (IPC), according to certain embodiments.

FIG. 4B is an FTIR spectra of bare alumina support, M50 (50 mg of the MIL-125-NH₂ MOF in 100 mL water deposited on an alumina support), M75 (75 mg of the MIL-125-NH₂ MOF in 100 mL water deposited on an alumina support), and M100 (100 mg of the MIL-125-NH₂ MOF in 100 mL water deposited on an alumina support), according to certain embodiments.

FIG. 4C is an XRD pattern of the bare alumina support, M50, M75, and M100, according to certain embodiments.

FIG. 5A is an SEM image of the bare alumina support with a scale of 20 μm, according to certain embodiments.

FIG. 5B is an SEM image of the bare alumina support with a scale of 10 μm, according to certain embodiments.

FIG. 5C is an SEM image of the bare alumina support with a scale of 5 μm, according to certain embodiments.

FIG. 5D is an SEM image of M50 with a scale of 20 μm, according to certain embodiments.

FIG. 5E is an SEM image of M50 with a scale of 5 μm, according to certain embodiments.

FIG. 5F is an SEM image of M50 with a scale of 1 μm, according to certain embodiments.

FIG. 5G is an SEM image of M75 with a scale of 20 μm, according to certain embodiments.

FIG. 5H is an SEM image of M75 with a scale of 5 μm, according to certain embodiments.

FIG. 5I is an SEM image of M75 with a scale of 1 μm, according to certain embodiments.

FIG. 5J is an SEM image of M100 with a scale of 20 μm, according to certain embodiments.

FIG. 5K is an SEM image of M100 with a scale of 5 μm, according to certain embodiments.

FIG. 5L is an SEM image of M100 with a scale of 1 μm, according to certain embodiments.

FIG. 6A is an SEM-EDX map of M75 with a scale of 5 μm, according to certain embodiments.

FIG. 6B is an EDX spectrum of M75, according to certain embodiments.

FIG. 6C is an elemental mapping image for C distribution in M75, according to certain embodiments.

FIG. 6D is an elemental mapping image for O distribution in M75, according to certain embodiments.

FIG. 6E is an elemental mapping image for Ti distribution in M75, according to certain embodiments.

FIG. 6F is an elemental mapping image for silicon (Si) distribution in M75, according to certain embodiments.

FIG. 6G is an elemental mapping image for aluminum (Al) distribution in M75, according to certain embodiments.

FIG. 6H is an elemental mapping image for N distribution in M75, according to certain embodiments.

FIG. 7A depicts a contact angle measurement of M75 in various media, including water in air, oil in air, and oil underwater environment, according to certain embodiments.

FIG. 7B depicts temporal variation in contact angles of M75 for water in air, oil in air, and oil in an underwater environment, according to certain embodiments.

FIG. 7C is a size distribution curve of oil droplets in a surfactant-stabilized crude oil-in-water emulsion, according to certain embodiments.

FIG. 8A is a graph depicting effect of pressure on pure water flux of M50, M75, and M100, according to certain embodiments.

FIG. 8B is a graph depicting influence of applied pressure on flux of M50, M75, and M100 using a 100 parts per million (ppm) crude oil-in-water emulsion as feed, according to certain embodiments.

FIG. 8C is a graph depicting separation efficiency of M50, M75, and M100 using a 100 ppm crude oil-in-water emulsion as feed, according to certain embodiments.

FIG. 9A depicts digital images of a feed and permeate samples at 0.5 bar, 1.0 bar, 1.5 bar, 2.0 bar trans-membrane pressure, according to certain embodiments.

FIG. 9B depicts an optical visualization of a feed sample with a 100-ppm crude oil-in-water emulsion, according to certain embodiments.

FIG. 9C depicts an optical visualization of a permeate at 0.5 bar trans-membrane pressure with M100 and a crossflow filtration system, according to certain embodiments.

FIG. 9D depicts an optical visualization of a permeate at 1 bar trans-membrane pressure with M100 and a crossflow filtration system, according to certain embodiments.

FIG. 9E depicts an optical visualization of a permeate at 1.5 bar trans-membrane pressure with M100 and a crossflow filtration system, according to certain embodiments.

FIG. 9F depicts an optical visualization of a permeate at 2 bar trans-membrane pressure with M100 and a crossflow filtration system, according to certain embodiments.

FIG. 10 is a graph depicting oil-water separation efficiency for the bare alumina support and M100 using 100 ppm crude oil-in-water emulsion at 1 bar, according to certain embodiments.

FIG. 11A is a digital image of the bare alumina support after testing with 100 ppm crude oil-in-water emulsion for 360 minutes (min) under a crossflow filtration mode, according to certain embodiments.

FIG. 11B is a digital image of M100 after testing with 100 ppm crude oil-in-water emulsion for 360 min under a crossflow filtration mode, according to certain embodiments.

FIG. 12A depicts permeate flux over time for M50, M75, and M100 using 100 ppm crude oil-in-water emulsion as feed, according to certain embodiments.

FIG. 12B depicts separation efficiencies over time for M50, M75, and M100 using 100 ppm crude oil-in-water emulsion as feed, according to certain embodiments.

FIG. 12C is a schematic illustration of a surfactant-stabilized crude oil-in-water emulsion separation mechanism using super-hydrophilic and underwater super-oleophobic MOF-based ceramic membranes in a crossflow filtration system, according to certain embodiments.

FIG. 13A is a stability curve of normalized flux for M100, according to certain embodiments.

FIG. 13B is a stability curve of separation efficiency for M100, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

When amounts, concentrations, dimensions, and other parameters are expressed in the form of a range, a preferable range, an upper limit value, a lower limit value, or preferable upper and/or limit values, it should be understood that any ranges obtainable by combining any upper limit or preferable value with any lower limit or preferable value are also specifically disclosed, irrespective of whether the obtained ranges are clearly mentioned in the context.

As used herein, the term “nanocomposite” refers to a composite material that has at least one component with a grain size measured in nanometers (nm). The term nanocomposite may refer to a material composed of two or more distinct components, at least one of which has a nanoscale structure, typically in the range of 1 to 100 nm. These components are combined to form a composite material that exhibits properties, such as increased strength, electrical conductivity, chemical reactivity, and/or thermal stability, compared to the individual components. Nanocomposites may be used in various applications, including catalysis, environmental remediation, electronics, and materials science.

As used herein, the term “room temperature” refers to a temperature in a range of 25±3 degrees Celsius (° C.).

As used herein, the term “ultrasonication” or “sonication” refers to a process in which sound waves are used to agitate particles in a solution.

As used herein, the term “calcination” refers to heating a compound to a high temperature under a restricted supply of ambient oxygen. Calcination may be performed to remove impurities or volatile substances and/or to incur thermal decomposition.

As used herein, the term “pore” refers to an opening or space in a material, such as rock or solid, through which fluids or gases can pass.

As used herein, the term “porosity” refers to a measure of void spaces in a material, typically expressed as a percentage of the total volume.

As used herein, the term “metal-organic framework(s)” or “MOF(s)” refers to compounds having a lattice structure made from (i) a cluster of metal ions as vertices (“cornerstones”) (secondary building units or SBUs) which are metal-based inorganic groups, for example metal oxides and/or hydroxides, linked together by (ii) organic linkers. The linkers are usually at least bidentate ligands which coordinate to the metal-based inorganic groups via functional groups such as carboxylates and/or amines. MOFs are considered coordination polymers made up of (i) the metal ion clusters and (ii) linker building blocks.

As used herein, the term “membrane” refers to a porous structure that is capable of separating components of a homogeneous or heterogeneous fluid. In particular, pores in the membrane allow fluid communication between different sides of the structure. When a homogeneous or heterogeneous fluid is passed through the membrane, some components of the fluid can pass through the pores of the membrane into a “permeate stream,” some components of the fluid can be retained by the membrane and can thus accumulate in a “retentate,” and/or some components of the fluid can be rejected by the membrane into a “rejection stream.” Membranes can be of various thicknesses, with homogeneous or heterogeneous structures. Membranes can be in the form of flat sheets or bundles of hollow fibers. Membranes can also be in various configurations including, but not limited to, spiral wound, tubular, hollow fiber, a combination thereof, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term “contact angle” is the angle between a liquid surface and a solid surface where the liquid surface and the solid surface meet. It is the angle between the surface tangent on the liquid-vapor interface and the tangent on the solid-liquid interface at their intersection. If a water contact angle is less than 90 degrees (°), the solid surface is considered hydrophilic. If the water contact angle is greater than 90°, the solid surface is considered hydrophobic.

As used herein, the term “air contact angle” is the angle formed between the tangent to a liquid droplet and the solid surface on which the droplet rests, with the surrounding environment being air. It serves as an indicator of the surface's wettability. A contact angle less than 90° suggests hydrophilic properties and a contact angle greater than 90° indicates hydrophobic properties.

As used herein, the term “water permeability” refers to the ability of a material to allow water to pass through it. It is typically quantified as a rate at which water flows through a material under a given pressure.

As used herein, the term “surfactant” refers to a compound that lowers the surface tension (or interfacial tension) between two liquids, between a liquid and a gas, or between a liquid and a solid. A surfactant molecule includes one or more hydrophilic head units attached to one or more hydrophobic tails. The tail of most surfactants includes a hydrocarbon chain, which can be branched, linear, or aromatic. Fluorosurfactants have fluorocarbon chains. Siloxane surfactants have siloxane chains. Gemini surfactant molecules include two or more hydrophilic heads and two or more hydrophobic tails. Many surfactants include a polyether chain terminating in a highly polar anionic group. The polyether groups often include ethoxylated (polyethylene oxide-like) sequences inserted to increase the hydrophilic character of a surfactant. Alternatively, polypropylene oxides may be inserted to increase the lipophilic character of a surfactant.

Cationic surfactants have cationic (positively charge) functional groups at their head, such as primary and secondary amines. Cationic surfactants include octenidine dihydrochloride, cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), a combination thereof, and the like. A cationic surfactant may be replaced by a nonionic surfactant, an anionic surfactant, a viscoelastic surfactant, a zwitterionic surfactant, a combination thereof, and the like.

Anionic surfactants contain anionic (negatively charged) functional groups at their head, such as sulfate, sulfonate, phosphate, and carboxylate. An anionic surfactant may be an alkyl sulfate, an alkyl ether sulfate, an alkyl ester sulfonate, an alpha olefin sulfonate, a linear alkyl benzene sulfonate, a branched alkyl benzene sulfonate, a linear dodecylbenzene sulfonate, a branched dodecylbenzene sulfonate, an alkyl benzene sulfonic acid, a dodecylbenzene sulfonic acid, a sulfosuccinate, a sulfated alcohol, a ethoxylated sulfated alcohol, an alcohol sulfonate, an ethoxylated and propoxylated alcohol sulfonate, an alcohol ether sulfate, an ethoxylated alcohol ether sulfate, a propoxylated alcohol sulfonate, a sulfated nonyl phenol, an ethoxylated and/or propoxylated sulfated nonyl phenol, a sulfated octyl phenol, an ethoxylated and/or propoxylated sulfated octyl phenol, a sulfated dodecyl phenol, an ethoxylated and propoxylated sulfated dodecyl phenol, and combination thereof, and the like. Other anionic surfactants include, but are not limited to, ammonium lauryl sulfate, sodium lauryl sulfate (sodium dodecyl sulfate, SLS, or SDS), and related alkyl-ether sulfates sodium laureth sulfate (sodium lauryl ether sulfate or SLES), sodium myreth sulfate, docusate (dioctyl sodium sulfosuccinate), perfluorooctanesulfonate (PFOS), perfluorobutanesulfonate, alkyl-aryl ether phosphates, and alkyl ether phosphates.

Zwitterionic (amphoteric) surfactants have both cationic and anionic groups attached to the same molecule. Zwitterionic surfactants include, but are not limited to, CHAPS (3-[(3-cholamidopropyl)dimethylammonio]-1-propanesulfonate), cocamidopropyl hydroxysultaine, ocamidopropyl betaine, phospholipids, sphingomyelins, a combination thereof, and the like.

Nonionic surfactants have a polar group that does not have a charge. These include long chain alcohols that exhibit surfactant properties, such as cetyl alcohol, stearyl alcohol, cetostearyl alcohol, oleyl alcohol, other fatty alcohols, a combination thereof, and the like. Other long chain alcohols with surfactant properties include, but are not limited to, polyethylene glycols of various molecular weights; polyethylene glycol alkyl ethers having the formula: CH₃(CH₂)₁₀₋₁₆(OC₂H₄)₁₋₂₅OH, such as octaethylene glycol monododecyl ether and pentaethylene glycol monododecyl ether; polypropylene glycol alkyl ethers having the formula: CH₃(CH₂)₁₀₋₁₆(OC₃H₆)₁₋₂₅OH; glucoside alkyl ethers having the formula: CH₃(CH₂)₁₀₋₁₆(O-glucoside)₁₋₃OH, such as decyl glucoside, lauryl glucoside, octyl glucoside; polyethylene glycol octylphenyl ethers having the formula: C₈H₁₇(C₆H₄)(OC₂H₄)₁₋₂₅OH, such as Triton X-100; polyethylene glycol alkylphenyl ethers having the formula: C₉H₁₉—(C₆H₄)(OC₂H₄)₁₋₂₅OH, such as nonoxynol-9; glycerol alkyl esters such as glyceryl laurate; polyoxyethylene glycol sorbitan alkyl esters such as polysorbate, sorbitan alkyl esters, cocamide MEA, cocamide DEA, dodecyldimethylamine oxide, block copolymers of polyethylene glycol, polypropylene glycol such as poloxamers, and polyethoxylated tallow amine (POEA).

A dendritic surfactant molecule may include at least two lipophilic chains that have been joined at a hydrophilic center and have a branch-like appearance. In each dendritic surfactant, there may be from about 2 lipophilic moieties independently to about 4 lipophilic moieties attached to each hydrophilic group, or up to about 8 lipophilic moieties attached to the hydrophilic group, for example. “Independently” as used herein with respect to ranges means that any lower threshold may be combined with any upper threshold. The dendritic surfactant may have better repulsion effects as a stabilizer at an interface and/or better interactions with a polar oil, as compared with other surfactants. Dendritic surfactant molecules are sometimes called “hyperbranched” molecules.

A dendritic extended surfactant is a dendritic surfactant having a non-ionic spacer arm between the hydrophilic group and a lipophilic tail. For example, the non-ionic spacer-arm extension may be the result of polypropoxylation, polyethoxylation, or a combination of the two with the polypropylene oxide next to the tail and the polyethylene oxide next to the head. The spacer arm of a dendritic extended surfactant may contain from about 1 independently to about 20 propoxy moieties and/or from about 0 independently to about 20 ethoxy moieties. Alternatively, the spacer arm may contain from about 2 independently up to about 16 propoxy moieties and/or from about 2 independently up to about 8 ethoxy moieties. The spacer arm extensions may also be formed from other moieties including, but not necessarily limited to, glyceryl, butoxy, glucoside, isosorbide, xylitols, and the like. For example, the spacer arm of a dendritic extended surfactant may contain both propoxy and ethoxy moieties. The polypropoxy portion of the spacer arm may be considered lipophilic; however, the spacer arm may also contain a hydrophilic portion to attach the hydrophilic group. The hydrophilic group may generally be a polyethoxy portion having about two or more ethoxy groups. These portions are generally in blocks, rather than being randomly mixed. Further, the spacer arm extension may be a poly-propylene oxide chain.

Another type of surfactant is a viscoelastic surfactant (VES). Conventional surfactant molecules are characterized by having one long hydrocarbon chain per surfactant head-group. In a viscoelastic gelled state these molecules aggregate into worm-like micelles. A viscoelastic gel is a gel that has elastic properties, meaning that the gel at least partially returns to its original form when an applied stress is removed. Typical viscoelastic surfactants include N-erucyl-N,N-bis(2-hydroxyethyl)-N-methyl ammonium chloride and potassium oleate, solutions of which form gels when mixed with inorganic salts such as potassium chloride and/or with organic salts such as sodium salicylate. Previously described surfactants may also be considered viscoelastic surfactants.

As used herein, the term “water flux” refers to the rate at which water passes through a membrane per unit area per unit of time. It is typically expressed in units of liters per square meter per hour (L m⁻² h⁻¹) or gallons per square foot per day (GFD). Water flux indicates the efficiency of a membrane in allowing water to flow through it, with higher flux values representing better performance in terms of throughput. In membrane applications, water flux may be influenced by factors such as membrane permeability, pressure differential, temperature, and/or the concentration of solutes and/or particles in a feed.

As used herein, the term “filtrate” refers to liquid that has passed through a filter during a filtration process, typically containing fewer or no particles or impurities compared to an original mixture. It is the filtered substance collected after separation.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include 160, 170, and 180. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to a ceramic membrane including a stable, uniformly structured active layer consisting of a MIL-125-NH₂ MOF deposited on a ceramic alumina support. The active layer is covalently bonded via interfacial polymerization using isophthaloyl chloride (IPC) as a crosslinker. The membrane exhibits super-hydrophilic properties in air and super-oleophobic properties underwater, with oil rejection exceeding 99% in oil/water (O/W) separation. The membrane demonstrates high water flux under transmembrane pressure and stable performance during extended filtration, providing an effective solution for O/W emulsion separation and desalination.

According to a first aspect of the present disclosure, a membrane is described. The membrane includes a first layer including a ceramic alumina support and a second layer including particles of a MIL-125-NH₂ metal-organic framework (MOF) crosslinked with isophthaloyl units of isophthaloyl. In alternate embodiments, silica, titania, zirconia, and magnesia may also be used in place of or in combination with the ceramic alumina support. MIL-125-NH₂ is a metal-organic framework comprising secondary building units (SBUs) composed of coordinated Ti⁴⁺ ions linked together by 2-aminoterephthalic anions (ATA).

MOF-based membranes are appealing due to their ordered, porous structures formed by metal nodes coordinated to organic linkers. This framework allows for control over pore size and functionality, facilitating selective separation and transport of molecules based on size, charge, and affinity. MOF-based membranes exhibit high permeability, tunable selectivity, and stability, making them applicable in gas separation, water purification, and molecular sieving situations.

One or more amine groups of the MIL-125-NH₂ MOF is covalently bonded to one or more acid groups of the isophthaloyl units, thereby creating a stable and robust structure. In some embodiments, a first amine group of a first MIL-125-NH₂ MOF is covalently bonded to a first acid group of a first unit of the isophthaloyl units and a second acid group of the first unit of the isophthaloyl units is covalently bonded to a first amine group of a second MIL-125-NH₂ MOF. In some embodiments, covalent bonds between the one or more amine groups of the MIL-125-NH₂ MOF and the one or more acid groups of the isophthaloyl units are formed through interfacial polymerization. Covalent bonding through interfacial polymerization promotes durability and integrity of the second layer.

In alternative embodiments, the second layer including particles of the MIL-125-NH₂ MOF may be crosslinked with other reacted crosslinkers, such as reacted units of terephthaloyl chloride, reacted units of phthalic anhydride, reacted units of other suitable diacid chlorides, a combination thereof, and the like. In some embodiments, other crosslinkers may be used to crosslink the MIL-125-NH₂ MOF, offering an ability to tailor the properties of the membrane for various applications. In alternative embodiments, other MOFs, such as ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, ZIF-725, UiO-66, MIL-101, a combination thereof, and the like may be used in place of or in combination with MIL-125-NH₂ in the second layer as an active layer material, depending on various membrane characteristics such as pore size, surface chemistry, or thermal stability.

The membrane is porous. A porous material is the one that forms a porous bulk solid. Pores may be micropores, mesopores, macropores, and/or a combination thereof. The pores exist in the bulk material, not necessarily in the molecular structure of the material. The term “microporous” refers to pores in a membrane having an average pore width (i.e., diameter) of less than 2 nm. The term “mesoporous” refers to pores of a membrane having an average pore width of 2-50 nm. The term “microporous” refers to pores of membrane having an average pore width greater than 50 nm. Pore size may be determined by methods including, but not limited to, gas adsorption (e.g., N₂ adsorption), mercury intrusion porosimetry, and imaging techniques such as scanning electron microscopy (SEM), and X-ray computed tomography (XRCT).

The membrane is porous with a pore size of 0.01-0.2 micrometers (μm), preferably 0.02-0.19 μm, preferably 0.03-0.18 μm, preferably 0.04-0.17 μm, preferably 0.05-0.16 μm, preferably 0.06-0.15 μm, preferably 0.07-0.14 μm, preferably 0.08-0.13 μm, preferably 0.09-0.12 μm, and preferably 0.10-0.11 μm.

The particles of the second layer are in the shape of discs having a longest dimension of 0.5-3 μm, preferably 0.6-2.9 μm, preferably 0.7-2.8 μm, preferably 0.8-2.7 μm, preferably 0.9-2.6 μm, preferably 1.0-2.5 μm, preferably 1.1-2.4 μm, preferably 1.2-2.3 μm, preferably 1.3-2.2 μm, preferably 1.4-2.1 μm, preferably 1.5-2.0 μm, preferably 1.6-1.9 μm, and preferably 1.7-1.8 μm. In alternate embodiments, the particles of the second layer may exist in different shapes such as spheres, rods, cylinders, rectangles, triangles, pentagons, hexagons, prisms, flowers, platelets, flakes, cubes, cuboid, cones, pyramidal, cylindrical, wires, crystals, ribbons, blocks, beads, barrels, granules, whiskers, foils, powders, boxes, stars, urchins, a combination thereof, and the like.

In some embodiments, the particles in the second layer are stacked and agglomerated having an average stacked height of 0.2 to 4 μm, preferably 0.3 to 3 μm, preferably 0.4 to 2 μm, and preferably 1 to 1.5 μm. This may enhance the structural integrity and functionality of the second layer. In some embodiments, the particles in the second layer are in the shape of discs and are stacked on one another. In some embodiments, the particles in the second layer are in the shape of discs and are stacked in a group (i.e., a row and/or a column) of 2 to 50, preferably 3 to 40, preferably 4 to 30, preferably 5 to 20, and preferably 10 to 15. In some embodiments, the particles in the second layer are in the shape of discs and are stacked on top of one another via a flat side of the disk. In other embodiments, the particles in the second layer are in the shape of discs and are stacked on top of one another via a flat side of a first disk and a rounded side of a second disk so that the first disk and the second disk are perpendicular to each other. The second layer provides a highly functionalized, stable coating that can enhance the material's properties, such as improve mechanical strength, chemical stability, and selective permeability.

In some embodiments, the MIL-125-NH₂ metal-organic framework has an average particle size of 0.5 to 0.9 μm, preferably 0.55 to 0.85 μm, preferably 0.6 to 0.8 μm, and preferably 0.65 to 0.75 μm.

The Brunauer-Emmett-Teller (BET) hypothesis is an analysis method for determining specific surface area of a material. It relates to the physical adsorption of gas molecules on a solid surface. Specific surface area is a property of solids, which is the total surface area of a material per unit of mass, solid or bulk volume, or cross-sectional area. In some embodiments, pore diameter, pore volume, and BET surface area are measured by gas adsorption analysis, preferably N₂ adsorption analysis (e.g., N₂ adsorption isotherms). In some embodiments, the MIL-125-NH₂ metal-organic framework has a BET surface area of 900-1000 square meters per gram (m²/g), preferably 910-995 m²/g, preferably 920-990 m²/g, preferably 930-985 m²/g, preferably 940-980 m²/g, preferably 950-975 m²/g, more preferably 960-970 m²/g, and yet more preferably about 965 m²/g. In a preferred embodiment, the MIL-125-NH₂ metal-organic framework has a BET surface area of 965 m²/g, which may enhance its adsorption capacity and filtration efficiency.

In some embodiments, the MIL-125-NH₂ metal-organic framework is porous and has a micropore surface area of 700-750 m²/g, preferably 705-745 m²/g, preferably 710-740 m²/g, more preferably 715-735 m²/g, and yet more preferably 720-730 m²/g, and a micropore volume of 0.25-0.3 cubic centimeters per gram (cm³/g), preferably 0.26-0.29 cm³/g, and more preferably 0.27-0.28 cm³/g. In a preferred embodiment, the MIL-125-NH₂ metal-organic framework is porous and has a micropore surface area of about 723 m²/g and a micropore volume of about 0.282 cm³/g.

In some embodiments, the MIL-125-NH₂ metal-organic framework is porous and has a pore width of 0.88-0.9 nm, preferably 0.881-0.899 nm, preferably 0.882-0.898 nm, preferably 0.883-0.897 nm, preferably 0.884-0.896 nm, preferably 0.885-0.895 nm, preferably 0.886-0.894 nm, preferably 0.887-0.893 nm, preferably 0.888-0.892 nm, and preferably 0.889-0.891 nm, and an average pore diameter of 1.5-2 nm, preferably 1.6-1.9 nm, and preferably 1.7-1.8 nm. In a preferred embodiment, the MIL-125-NH₂ MOF is porous and has a pore width of about 0.889 nm and an average pore diameter of about 1.7 nm.

In some embodiments, the membrane has a bulk porosity of 20-30%, preferably 21-29%, preferably 22-28%, preferably 23-27%, and preferably 24-26% based on a volume of voids in the membrane over the total volume of the membrane. In a preferred embodiment, the membrane has a bulk porosity of about 28% based on a volume of voids in the membrane over the total volume of the membrane. In another preferred embodiment, the membrane has a bulk porosity of about 22.66% based on a volume of voids in the membrane over the total volume of the membrane. In yet another preferred embodiment, the membrane has a bulk porosity of about 21.46% based on a volume of voids in the membrane over the total volume of the membrane.

In some embodiments, the membrane has a water in air contact angle of 0°, indicating super-hydrophilicity, which facilitates efficient water permeation. In some embodiments, the membrane has an oil in air contact angle of 0°, indicating strong oil affinity. In some embodiments, the membrane has an oil in water contact angle of 155-165°, preferably 156-164°, preferably 157-163°, preferably 158-162°, more preferably 160-162°, and yet more preferably about 160.5°, indicating underwater super-oleophobicity. An underwater super-oleophobicity characteristic prevents oil wetting in water and allows selective water passage, making the membrane effective for oil-water separation applications. The combination of super-hydrophilic and underwater super-oleophobic properties promote high separation efficiency, reduced fouling, and enhanced membrane performance in filtration processes.

In some embodiments, the membrane has a water permeability of distilled water of 500-1400 liters per square meter per hour per bar (L m⁻² h⁻¹ bar⁻¹), preferably 600-1300 L m⁻² h⁻¹ bar⁻¹, preferably 700-1200 L m⁻² h⁻¹ bar⁻¹, preferably 800-1100 L m² h⁻¹ bar⁻¹, and preferably 900-1000 L m⁻² h⁻¹ bar⁻¹ at a pressure of 1 bar. In some embodiments, the membrane has a water permeability from an oil-in-water emulsion of 300 to 500 L m⁻² h⁻¹ bar⁻¹, preferably 325 to 475 L m⁻² h⁻¹ bar⁻¹, preferably 350 to 450 L m⁻² h⁻¹ bar⁻¹, and preferably 375 to 425 L m⁻² h⁻¹ bar⁻¹. In a preferred embodiment, the membrane has a water permeability from an oil-in-water emulsion of about 316.90 L m⁻² h⁻¹ bar⁻¹ at a pressure of 1 bar. In another preferred embodiment, the membrane has a water permeability from an oil-in-water emulsion of about 371.83 L m⁻² h⁻¹ bar⁻¹ at a pressure of 1 bar. In yet another preferred embodiment, the membrane has a water permeability from an oil-in-water emulsion of about 498.59 L m⁻² h⁻¹ bar⁻¹ at a pressure of 1 bar.

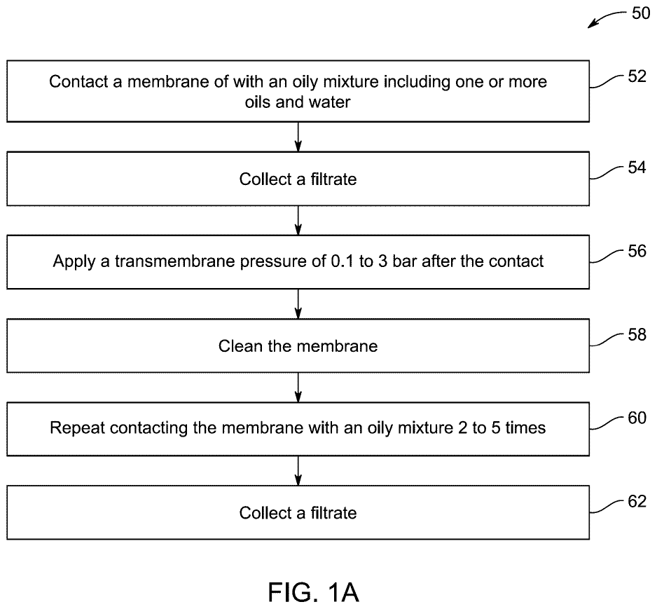

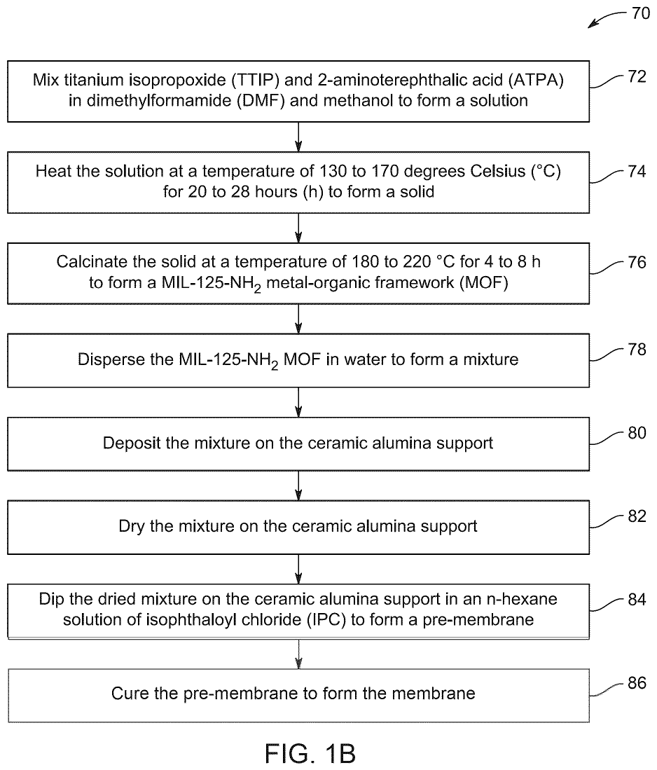

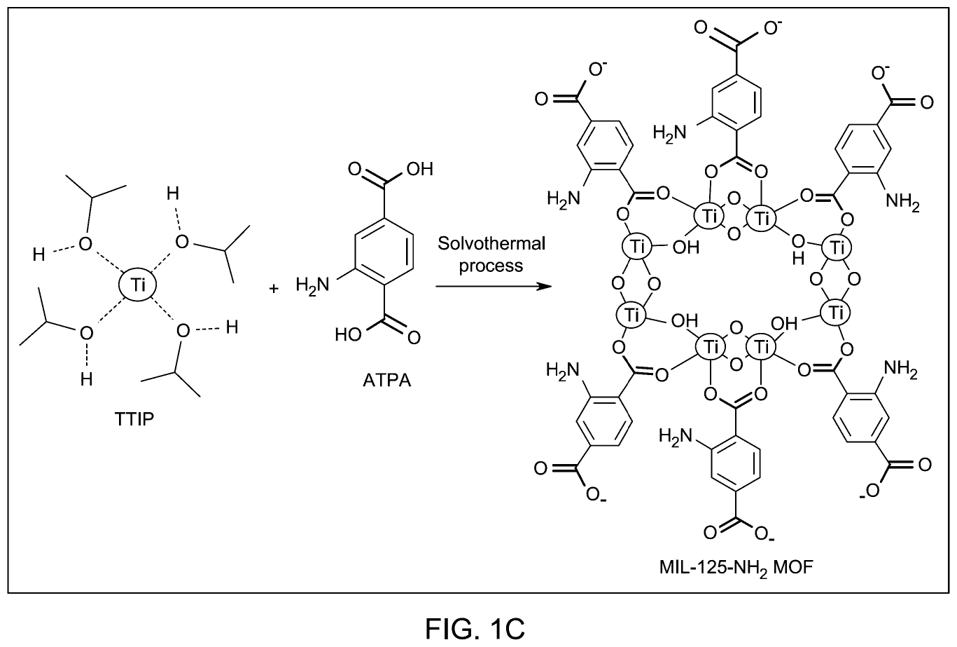

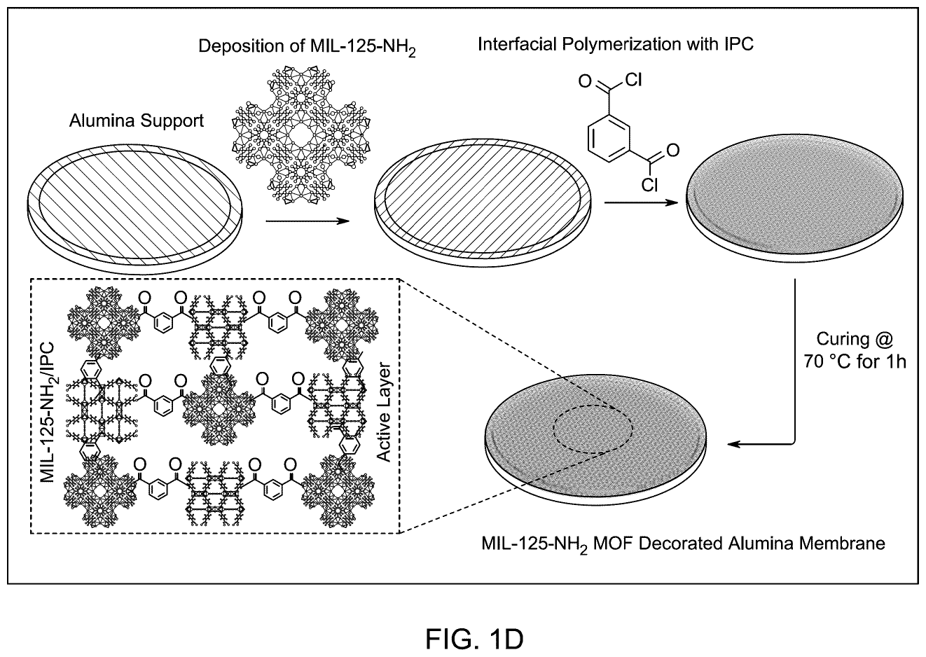

FIG. 1A illustrates a flow chart of a method 50 of oil separation. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes contacting the membrane with an oily mixture including one or more oils and water. In some embodiments, the oil may include, but is not limited to, crude oil, lubricating oils, vegetable oils (e.g., canola oil, soybean oil, palm oil, peanut oil, safflower oil, avocado oil, sunflower oil, coconut oil, grapeseed oil, flaxseed oil, mustard oil, sesame oil, corn oil, and olive oil), diesel oil, a combination thereof, and the like. In some embodiments, water may be tap water, distilled water, bi-distilled water, deionized water, deionized distilled water, reverse osmosis water, hard water, fresh water, brine/salt water, a combination thereof, and the like. The hard water and the freshwater may include salts of sodium, magnesium, calcium, potassium, ammonium, iron, a combination thereof, and the like, and anions such as chloride, bicarbonate, carbonate, sulfate, sulfite, phosphate, iodide, nitrate, acetate, citrate, fluoride, nitrite, a combination thereof, and the like. In some embodiments, the membrane has a separation efficiency of at least 98%, preferably at least 98.5%, preferably at least 99%, more preferably at least 99.5%, and yet more preferably more than at least 99.5% based on an initial amount of the one or more oils in the oily mixture. In some embodiments, the oily mixture includes a surfactant. In a preferred embodiment, the surfactant is a sodium dodecyl sulfate.

At step 54, the method 50 includes collecting a filtrate. The filtrate includes a lesser amount of the one or more oils in comparison to the amount of the one or more oils in the oily mixture, implying effective separation of oil from the oily mixture. In some embodiments, the filtrate may be collected through methods such as gravity filtration, vacuum filtration, centrifugation, pressure filtration, a combination thereof, and the like. In a preferred embodiment, the filtrate may be collected through a crossflow filtration mode. In “crossflow” filtration, the feed solution flows tangentially across the membrane surface, creating a flow pattern that helps to minimize membrane fouling. The filtered liquid, or permeate, is collected through the membrane, while the remaining particles or larger substances are retained on the membrane surface or not able to permeate and cross the membrane.

At step 56, the method 50 includes applying a transmembrane pressure of 0.1-3 bar, preferably 0.3-2.8 bar, preferably 0.5-2.6 bar, preferably 0.7-2.4 bar, preferably 0.9-2.2 bar, preferably 1.1-2.0 bar, preferably 1.3-1.8 bar, and preferably 1.5-1.6 bar after the contacting. Transmembrane pressure is the pressure difference between a feed side and a permeate side of a membrane during filtration. It drives the filtration process, with higher transmembrane pressure generally increasing the filtration rate.

At step 58, the method 50 optionally includes cleaning the membrane. The membranes may be cleaned using various methods depending on the type of fouling. Cleaning techniques may include rinsing the membrane with water and/or mild detergents, like Triton X-100, for organic fouling and acidic solutions, such as citric acid or hydrochloric acid, for scaling and mineral fouling. Alkaline solutions, like sodium hydroxide, may be effective for organic fouling and inorganic deposits, while enzymatic cleaning helps break down proteins and fats. Oxidizing agents, like chlorine or hydrogen peroxide, target biological fouling and solvents such as acetone or alcohols (i.e., methanol, ethanol, isopropanol) may be used to remove oils and organic compounds. Physical cleaning methods, including backwashing and ultrasonic cleaning and/or brushing for stubborn contaminants, may also aid in restoring membrane performance. In a preferred embodiment, the membrane is cleaned using methanol. The membrane may be dipped in clean methanol for 10-40 min, preferably 15-30 min, more preferably 18-25 min, and yet more preferably about 20 min. The cleaning process may help remove accumulated oil droplets and/or other contaminants from the membrane surface. Following this, the membrane may be reused with restored flux and separation efficiency. Cleaning with methanol may restore the membrane's performance by removing oil layers or fouling caused by emulsion filtration.

At step 60, the method 50 optionally includes repeating contacting the membrane with an oily mixture 2 to 5 times, preferably 3 to 4 times. Repeating the contacting does not lower separation efficiency, oil rejection rates, and/or membrane performance throughout the filtration process.

At step 62, the method 50 optionally includes collecting a filtrate. In some embodiments, collecting a filtrate occurs after the cleaning and the repeating contacting. in some embodiments, the membrane has a separation efficiency of at least 98% of that of an initial separation efficiency after the cleaning, the repeating contacting, and collecting a filtrate. This suggests that the membrane retains its performance over multiple filtration cycles, demonstrating its long-term stability and resistance to fouling. This high retention of separation efficiency ensures consistent performance during extended use in O/W separation.

FIG. 1B illustrates a flow chart of a method 70 of making the membrane. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes mixing titanium isopropoxide (TTIP) and 2-aminoterephthalic acid in dimethylformamide (DMF) and methanol to form a solution. Alternative polar solvents that may be used include, but are not limited to, C₁-C₈ alkanols, such as ethanol, n-propanol, isopropanol, n-butanol, sec-butanol and isobutanol; N-formyl morpholine; N-acetyl morpholine; acetonitrile; N,N-di(C₁-C₄)alkylacylamides, such as N,N-dimethylformamide, N,N-diethylformamide, N,N-dimethylacetamide (DMAc) and 3-methoxy N,N′-dimethylpropanamide (MDP); hexamethylphosphoramide; N-methylpyrrolidone (NMP); N-ethyl-2-pyrrolidone (NEP); N-butyl-2-pyrrolidone (NBP); pyridine; esters, such as (C₁-C₈)alkyl acetates, ethoxydiglycol acetate, dimethyl glutarate, dimethyl maleate, dipropyl oxalate, ethyl lactate, benzyl benzoate, butyloctyl benzoate and ethylhexyl benzoate; ketones, such as acetone, ethyl ketone, methyl ethyl ketone (2-butanone) and methyl isobutyl ketone, cyclohexanone and methylcyclohexanone; γ-butyrolactone; ethers, such as tetrahydrofuran (THF), 2-methyltetrahydrofuran (2-MeTHF) and 1,2-dimethoxyethane; 1,3-dioxolane; dimethyl sulfoxide (DMSO), a combination thereof, and the like.

In some embodiments, other metal precursors may be used in place of or in combination with TTIP, such as titanium tetrachloride, titanium butoxide, a combination thereof, and the like. In some embodiments, the mixing can be done by stirring, swirling, sonicating, a combination thereof, and the like to form the solution.

At step 74, the method 70 includes heating the solution at a temperature of 130 to 170° C., preferably 135 to 165° C., 140 to 160° C., more preferably 145 to 155° C., and yet more preferably about 150° C. for 20 to 28 hours (h), preferably 21-27 h, preferably 22-26 h, more preferably 23-25 h, and yet more preferably about 24 h to form a solid. In some embodiments, the heating can be performed by using heating appliances such as ovens, microwaves, autoclaves, hot plates, heating mantles and tapes, oil baths, salt baths, sand baths, air baths, hot-tube furnaces, hot-air guns, a combination thereof, and the like. In a preferred embodiment, the solution is transferred to a Teflon-lined stainless-steel autoclave and kept in heating oven.

At step 76, the method 70 includes calcinating the solid at a temperature of 180-220° C., preferably 185-215° C., preferably 190-210° C., more preferably 195-205° C., and yet more preferably about 200° C. for 4-8 h, preferably 4.5-7.5 h, preferably 5-7 h, more preferably 5.5-6.5 h, and yet more preferably about 6 h to form the MIL-125-NH₂ MOF. In a preferred embodiment, calcination is done at a temperature of 200° C. for 6 h. The calcination is carried out by heating the solid to a high temperature under a restricted supply of ambient oxygen. Calcination may be performed to remove impurities and/or volatile substances and/or to incur thermal decomposition.

Calcination may be carried out in a furnace preferably equipped with a temperature control system, which may provide a heating rate of up to 1° C. per minute (C/min), preferably up to 2° C./min, preferably up to 5° C./min, preferably up to 10° C./min, preferably up to 20° C./min, preferably up to 30° C./min, preferably up to 40° C./min, and preferably up to 50° C./min.

At step 78, the method 70 includes dispersing the MIL-125-NH₂ MOF in water to form a mixture. In some embodiments, an amount of the MIL-125-NH₂ MOF in water to form the mixture is from 30 to 120 milligrams (mg), preferably 40-110 mg, preferably 50-100 mg, preferably 60-90 mg, preferably 70-80 mg, and preferably 60-50 mg of the MIL-125-NH₂ MOF in 100 milliliters (mL) water. In a preferred embodiment, an amount of the MIL-125-NH₂ MOF in water to form the mixture is about 50 mg of the MIL-125-NH₂ MOF in 100 mL water. In another preferred embodiment, an amount of the MIL-125-NH₂ MOF in water to form the mixture is about 75 mg of the MIL-125-NH₂ MOF in 100 mL water. In yet another preferred embodiment, an amount of the MIL-125-NH₂ MOF in water to form the mixture is about 100 mg of the MIL-125-NH₂ MOF in 100 mL water. The dispersion can be achieved using various homogenizing methods, such as probe sonication or magnetic stirring, to ensure even distribution of the MIL-125-NH₂ MOF in solution. In a preferred embodiment, the dispersion is done by using probe sonication.

At step 80, the method 70 includes depositing the mixture on the ceramic alumina support. In some embodiments, the mixture may be deposited onto the ceramic alumina support by depositing the dispersed mixture and filtering on the ceramic alumina support in a dead-end filtration cell. In some embodiments, the mixture may be deposited on the ceramic alumina support by spray-coating, drop-casting, spin coating, dip coating methods, a combination thereof, and the like.

At step 82, the method 70 includes drying the mixture on the ceramic alumina support. The mixture is allowed to dry at room temperature or under controlled conditions to ensure the MIL-125-NH₂ MOF adheres to the ceramic alumina support. Drying may be done in air or in an oven set at a low temperature to avoid excessive drying. In a preferred embodiment, the mixture is dried on the ceramic alumina support in open air.

At step 84, the method 70 includes dipping the dried mixture on the ceramic alumina support in an n-hexane solution of IPC to form a pre-membrane. This facilitates the chemical bonding of the MIL-125-NH₂ MOF to the ceramic alumina support through interfacial polymerization, creating a stable and functional membrane. In some embodiments, toluene, xylene, chloroform, dichloromethane, acetone, ethanol, isopropanol, dimethylformamide, chlorobenzene, acetonitrile, a combination thereof, and the like may be used in place of or in combination with n-hexane as a solvent. In some embodiments, terephthaloyl chloride, 1,3,5-benzene-tricarboxylic acid chloride, isocyanates, a combination thereof, and the like may be used in place of or in combination with IPC as a crosslinker.

At step 86, the method 70 includes curing the pre-membrane at a temperature of 50-90° C., preferably 55-75° C., preferably 60-80° C., more preferably 65-75° C., and yet more preferably about 70° C. for 0.5-2 h, preferably 0.7-1.6, more preferably 0.9-1.1 h, and yet more preferably about 1 h to form the membrane. The curing promotes the IPC to form a stable bond with the MIL-125-NH₂ MOF and the ceramic alumina support, providing the membrane structure. Curing at a lower temperature ensures that the MIL-125-NH₂ MOF retains its structural integrity while allowing for the formation of strong polymeric bonds.

### EXAMPLES

The following examples describe and demonstrate a MIL-125-NH₂ metal organic framework (MOF) nanocomposite membrane for treating oily wastewater. The examples are provided solely for illustration and are not to be construed as limitations of the present disclosure, as many variations are possible without departing from the spirit and scope of the present disclosure.

### Example 1: Chemicals and Reagents

Titanium isopropoxide (TTIP), 2-aminoterephthalic acid (ATPA), isophthaloyl chloride (IPC), methanol, N,N-dimethyl formamide (DMF), and n-hexane were obtained from Sigma Aldrich (USA). The aluminum oxide (Al₂O₃) ceramic supports were purchased separately from HIGHBORN New Materials Co., LTD. in China.

### Example 2: Synthesis of MIL-125-NH₂ MOF

Synthesis of MIL-125-NH₂ MOF was carried out using solvothermal approach using aminotris (hydroxymethyl) methane (ATPA) as an organic linker and titanium tetraisopropoxide (TTIP) as a metal source. 0.56 grams (g) ATPA was dissolved in 70 milliliters (mL) of a 9:1 ratio mixture of DMF: methanol (CH₃OH), which was followed by the addition of 0.6 mL TTIP. The reaction mixture was stirred for 20 minutes (min) at room temperature. The reaction mixture was then transferred into a Teflon-lined stainless-steel autoclave, sealed, and kept in a heating oven at 150 degrees Celsius (° C.) for 24 hours (h). After 24 h, the autoclave was removed from the oven and allowed to cool down where MIL-125-NH₂ MOF was obtained as a yellow precipitate. The yellow precipitate was thoroughly washed with excess of DMF and methanol to remove residual reactants. The obtained MIL-125-NH₂ MOF was further refluxed in DMF for 2 h followed by isolation using centrifugation. Subsequently, the MIL-125-NH₂ MOF was washed with water and calcined at 200° C. for 6 h. The purified MIL-125-NH₂ MOF was characterized and used for membrane fabrication. The chemical reaction illustrated for the synthesis of MIL-125-NH₂ MOF using the solvothermal process is shown in FIG. 1C.

### Example 3: Fabrication of MIL-125-NH₂ MOF-Based Membranes

Interfacial polymerization was used to with IPC three different concentrations of MIL-125-NH₂ MOF to decorate the MIL-125-NH₂ MOF on an alumina ceramic support. In an example membrane fabrication procedure, an aqueous dispersion of MIL-125-NH₂ MOF was prepared by dispersing 50 milligrams (mg) of MIL-125-NH₂ MOF in 100 mL of distilled water and homogenized with a probe sonicator for 15 min. Filtration of the aqueous dispersion on the alumina support fixed in a dead-end-filtration cell (Sterlitech, Auburn, WA, USA) led to the deposition of MIL-125-NH₂ MOF onto the Al₂O₃ ceramic support. Subsequently, the MOF-deposited membrane was allowed to dry in open air. To stabilize the deposition of MIL-125-NH₂ MOF onto the alumina support, the dried membrane was dipped in a 0.15% weight by volume (wt/v) n-hexane solution of IPC for 30 min. The resultant membrane was washed with n-hexane to remove unreacted IPC. The MIL-125-NH₂ MOF ceramic membrane was then cured in an oven at 70° C. for 1 h. The obtained membrane was labelled as M50 (50 mg of MIL-125-NH₂ MOF in 100 mL of distilled water). The other two membranes, M75 and M100, were prepared using the same procedure except the concentration of MIL-125-NH₂ MOF was 75 mg MOF per 100 mL water and 100 mg MOF per 100 mL water, respectively. Steps involved in the fabrication of the MIL-125-NH₂ MOF decorated alumina ceramic membranes are shown in FIG. 1D. FIG. 1D also depicts various phases involved in the fabrication of the MIL-125-NH₂ MOF decorated alumina ceramic membranes using an interfacial polymerization process.

### Example 4: Characterizations

The crystal structure and order of the MIL-125-NH₂ MOF and the MIL-125-NH₂ MOF decorated alumina membranes (M50, M75, and M100) were evaluated using X-ray diffraction (XRD, MiniFlex-600, Rigaku). The analysis employed copper K-alpha (Kα) radiation with a wavelength of 1.542 angstroms (Å) and scanned a broad range of angles from 5 to 80° (degrees). Preceding XRD investigation, drying and micronization yielded homogeneous microcrystalline samples, subsequently mounted on a holder for data acquisition. Surface functionalities of the MIL-125-NH₂ MOF were characterized by Fourier-transform infrared (FTIR) spectroscopy (Nicolet iS-50, Thermo Fisher Scientific) with potassium bromide (KBr) pellets within a scanning wavelength range of 390 to 4000 wavenumber (cm⁻¹). The MIL-125-NH₂ MOF decorated alumina membranes were also evaluated using attenuated total reflectance Fourier-transform infrared (ATR-FTIR) spectroscopy. Before morphology analysis, the synthesized MIL-125-NH₂ MOF and the MIL-125-NH₂ MOF decorated alumina membranes were gold sputtered and analyzed using scanning electron microscopy coupled with energy dispersive X-ray spectroscopy (SEM/EDX, Coxem EM-30AX SEM) at a voltage of 10 kilovolts (kV). The surface wetting/non-wetting properties of the MIL-125-NH₂ MOF decorated alumina membranes were evaluated using the sessile drop method to analyze contact angles of water and oil, employing a goniometer (KRUSS, DSA25). Water contact angle measurements were carried out on the membranes in an air environment by depositing 2 microliters (μL) droplets at various locations. The subsequent contact angles were averaged and documented, providing a representation of the surface wettability. A similar procedure was employed for measuring the oil contact angle in an air environment, with a droplet concentration of 1 μL. Oil contact angle measurements were also conducted on the membrane in an underwater environment by directly injecting oil droplets onto the submerged membranes.

### Example 5: Filtration Experiment

Crossflow module was used to evaluate the permeate flux and oil rejection of M50, M75, and M100. The performance analysis was investigated at different trans-membrane pressures between 0.5 and 2 bars. The permeate flux (J) of each membrane was calculated using Equation 1:

$$j = \frac{V}{A \times t} \qquad ( 1 )$$

where V, A, and t are the permeate volume (L), membrane surface area (m²) and time (h), respectively. A stock solution of 1000 parts per million (ppm) oil-in-water (O/W) emulsion was prepared by mixing 1 g of crude oil in 1 liter (L) of distilled water. 0.5 g of sodium dodecyl sulfate (SDS) was added as an emulsifying agent using a shear mixer set at 30000 revolutions per minute (rpm). The stock solution was diluted with distilled water to prepare a 100 ppm crude O/W emulsion to be used as a feed solution. The separation efficiencies of membranes were calculated using Equation 2:

$$R ( \% ) = ( 1 - \frac{{C}_{p}}{{C}_{f}} ) \times 100 \qquad ( 2 )$$

where Cₚ is the oil concentration in the permeate and Cris the oil concentration in the feed.

The MIL-125-NH₂ MOF was synthesized using TTIP as a metal source and ATPA. The ATPA ligand was selected to obtain a MOF with built-in amino (—NH₂) functional groups so that it can readily take part in reactions with IPC during the interfacial polymerization. This approach will yield an active layer composed of decorated MIL-125-NH₂ MOF on the surface of alumina ceramic support.

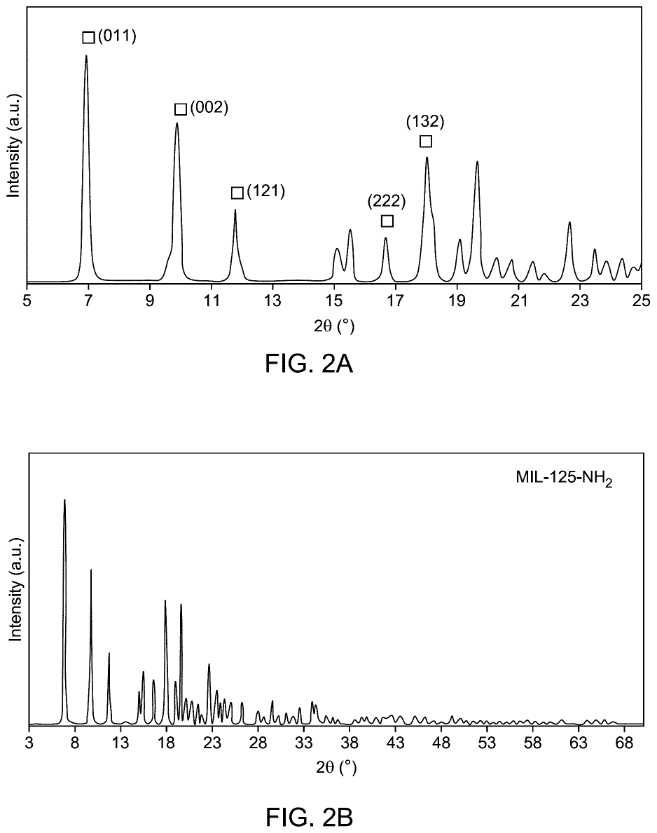

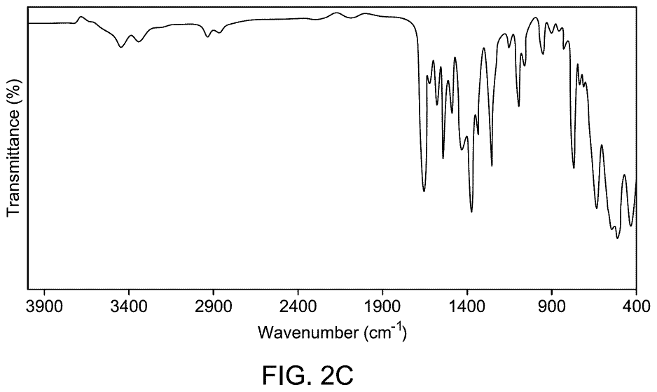

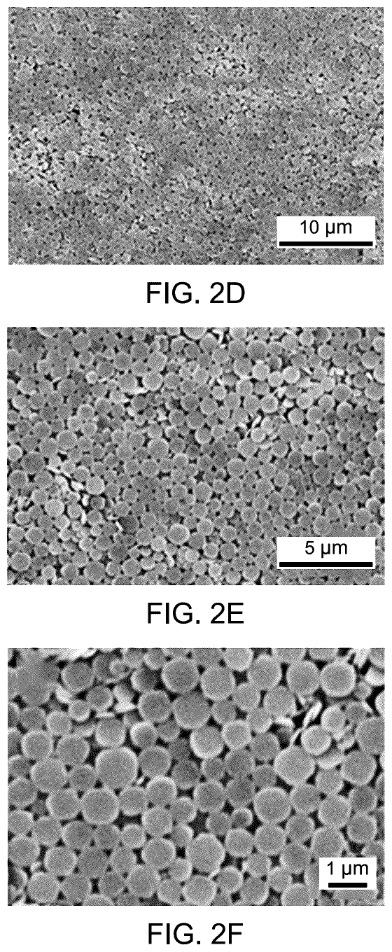

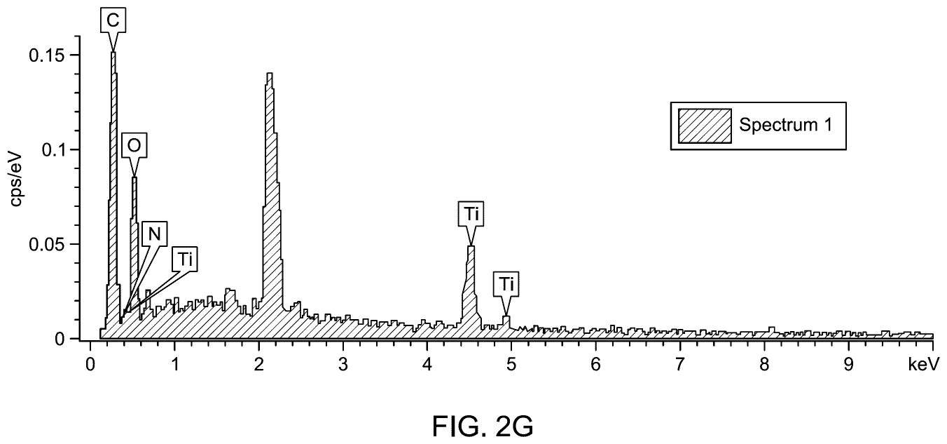

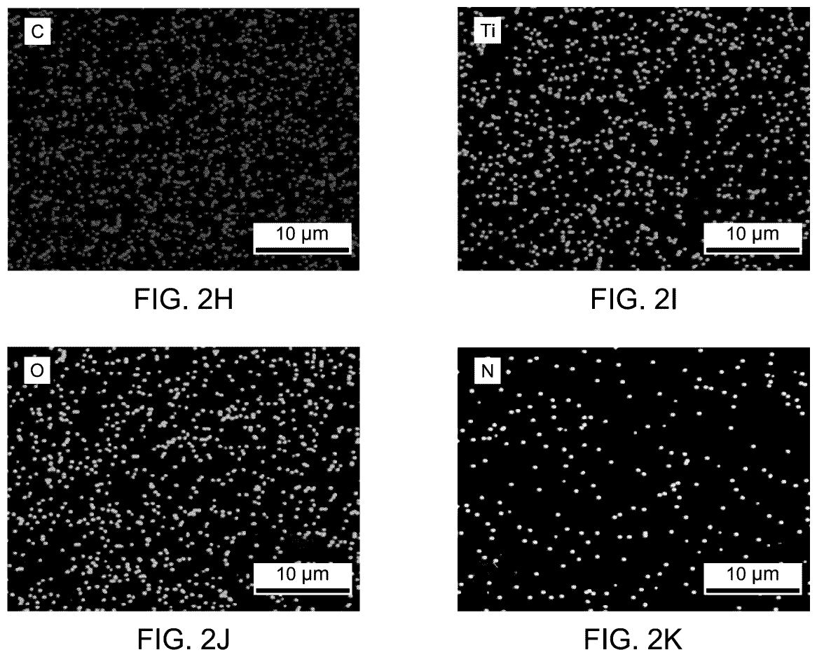

FIG. 2A is an X-ray diffraction (XRD) pattern of the MIL-125-NH₂ MOF with a 20 range of 5 to 25 degrees (°), and FIG. 2B is an XRD pattern of the MIL-125-NH₂ MOF with a 20 range of 5 to 70°. Distinct and intense diffraction peaks were observed for the MIL-125-NH₂ MOF at 20 angles of 6.89°, 9.85°, and 11.75°, corresponding to crystallographic planes (011), (002), and (121), respectively, as shown in FIG. 2A. The FTIR spectrum of MIL-125-NH₂ MOF revealed the chemical structure by documenting the characteristics peaks owing to the presence different constituents, as shown in FIG. 2C. The most prominent peak was observed at around 3400 cm⁻¹ which was observed as doublet of peaks which is a characteristic of a primary amine (—NH₂); therefore, supporting incorporation of the amino (—NH₂) group of the ATPA in the MIL-125-NH₂ MOF. Another set of peaks at approximately 3000 cm⁻¹ are attributed to sp2 C—H stretching of benzene rings in ATPA. A peak confirming the carbonyl (>C═O) group of carboxylic groups (—COOH) was found at 1532 cm⁻¹, as shown in FIG. 2C. The structure of the organic linker ATPA was confirmed by FTIR. Binding of the titanium metal with carboxylate groups was confirmed due to the existence of several Ti—O—Ti stretching vibrations at 774 cm⁻¹, 639 cm⁻¹, and 514 cm⁻¹.

FIGS. 2D-2F depict SEM images for the MIL-125-NH₂ MOF with a scale of 10 μm, 5 μm, and 1 μm, respectively. The surface morphology of the MIL-125-NH₂ MOF resembles thin disc-like structures with an estimated average particle size of about 0.7 μm arranged in uniform. FIG. 2G is an EDX spectra of the MIL-125-NH₂ MOF. EDX analysis confirmed the presence of elements including titanium (Ti), oxygen (O), carbon (C), and nitrogen (N), as shown in FIGS. 2H-2K, respectively. Elemental mapping revealed a uniform spatial distribution of the elements throughout the structure of the MIL-125-NH₂ MOF. The presence of these elements was attributed to TTIP and ATPA. The content of each element in the MIL-125-NH₂ MOF was reflected by the density of the mapping dots in the respective mapping image. Carbon had the highest content among all the elements and was a confirmatory indication of the participation ligand, ATPA, which was further confirmed by the presence of N owing to the presence of amino groups (—NH₂) in ATPA.

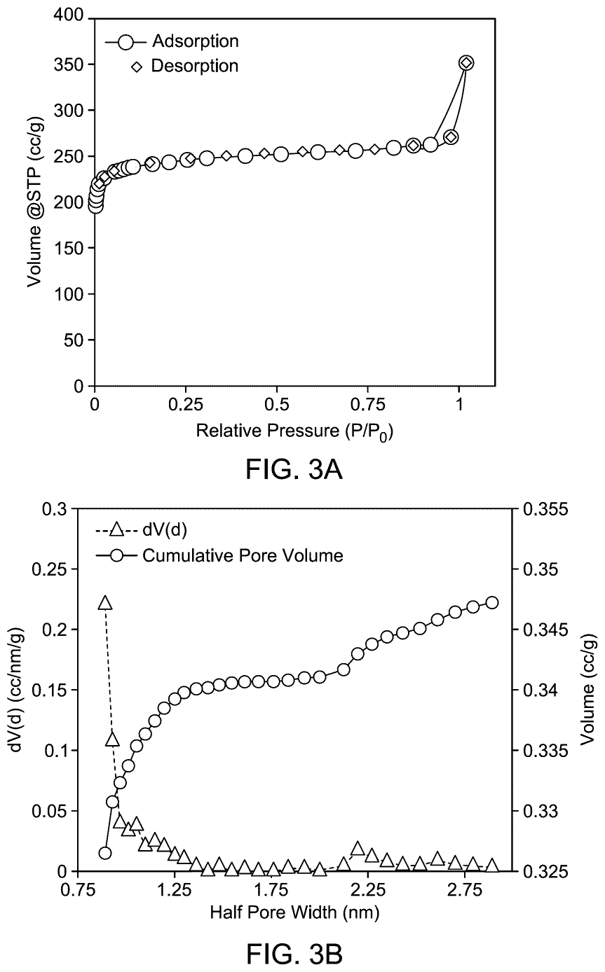

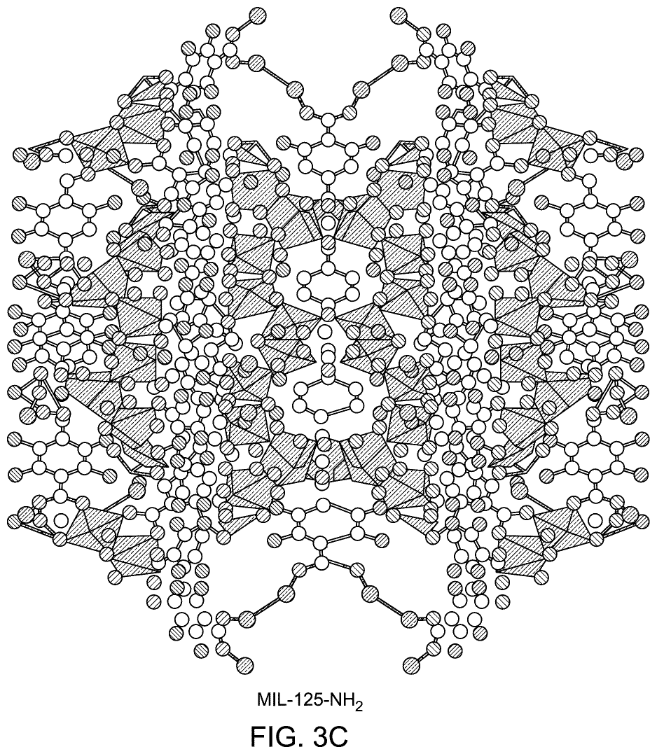

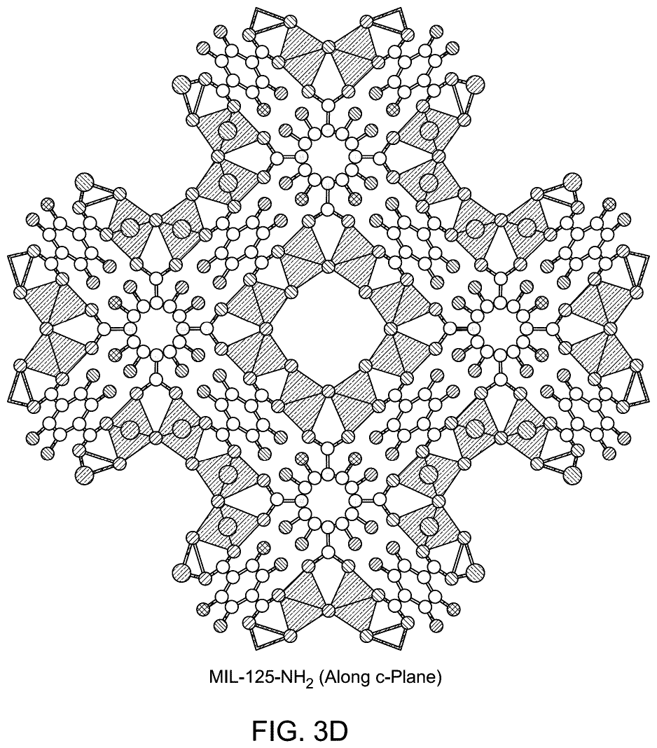

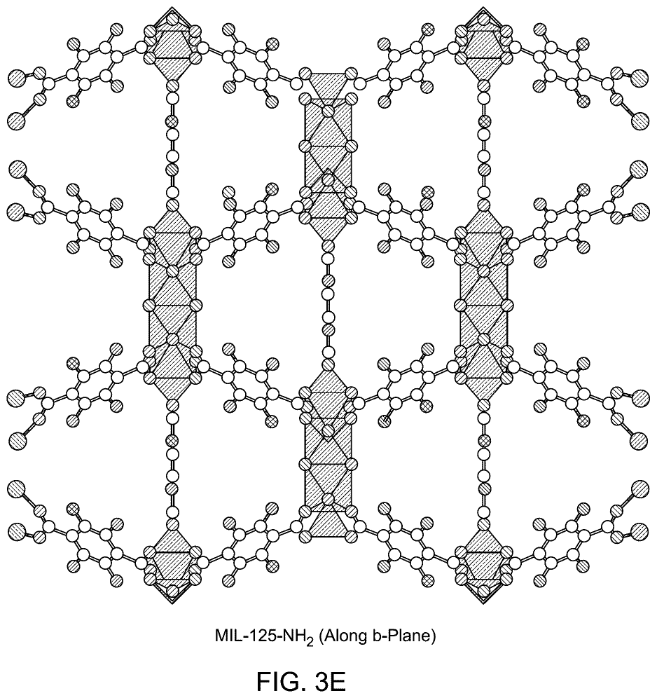

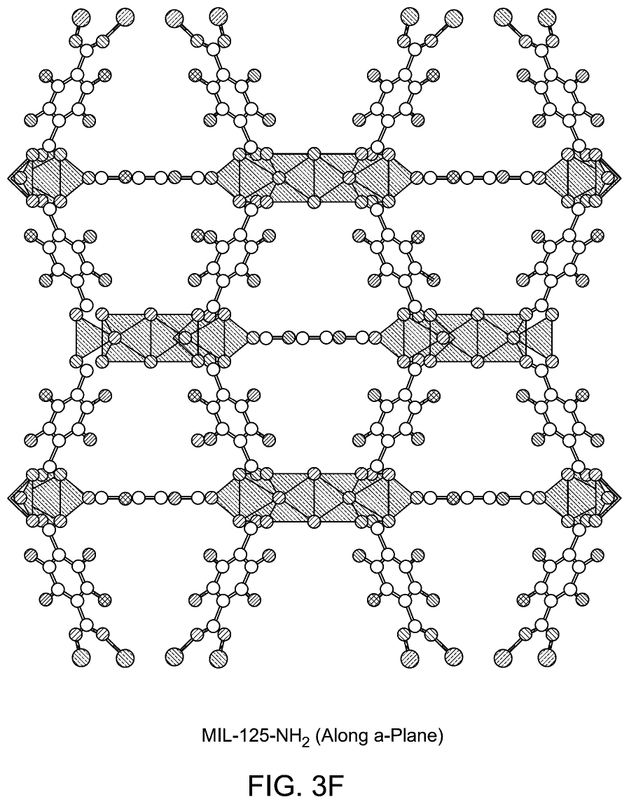

Nitrogen adsorption/desorption isotherm of the MIL-125-NH₂ MOF, as shown in FIG. 3A, revealed a type I isotherm at 77 K, with no hysteresis observed. The calculated BET surface area was 965 m²/g. In the low relative pressure region, the adsorption curve increased sharply, indicating the presence of micropores. The adsorption curve reached a plateau after that indicating that most of the MOF porosity was micropores. The calculated surface area and volume of the micropores were 723 m²/g and 0.282 cm³/g, respectively. The pore size distribution of the MOF is shown in FIG. 3B. The pore width (mode) was 0.889 nm with an average pore diameter of 1.7 nm. The total pore volume at a relative pressure (barᵣₑₗ) of 0.926 was 0.341 cm³/g indicating that more than 80% of the pores were micropores. The adsorption isotherms of N₂ on MIL-125-NH₂ MOF revealed that the MIL-125-NH₂ MOF has a high adsorption capacity at low partial pressures. Within a wide range, the adsorption amount exhibited little changes until reaching saturation pressure, where it rapidly increases. This phenomenon may be elucidated by considering the energy distribution of adsorption sites within the MOF structure and the presence of multiple peak energy distribution functions. At low partial pressures, the availability of vacant adsorption sites allowed for efficient adsorption of N₂ molecules, resulting in high adsorption capacity. As the partial pressure increases, the competition for these adsorption sites becomes more pronounced, leading to diminishing changes in adsorption amount; however, at saturation pressure, additional adsorption sites may have become accessible due to structural rearrangements or cooperative interactions between N₂ molecules and the MOF, resulting in the observed increase in adsorption capacity. The different structures of the MIL-125-NH₂ MOF exhibited different orientations along various planes and symmetries, depicting the porosity of the synthesized MIL-125-NH₂ MOF, as shown in FIGS. 3C-3F.

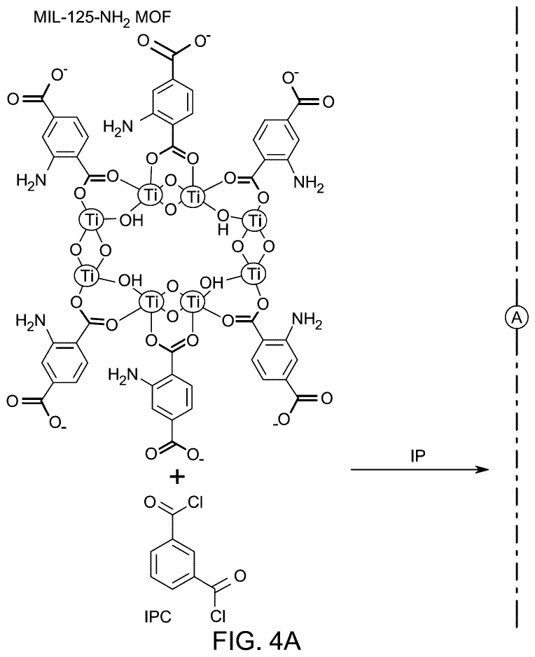

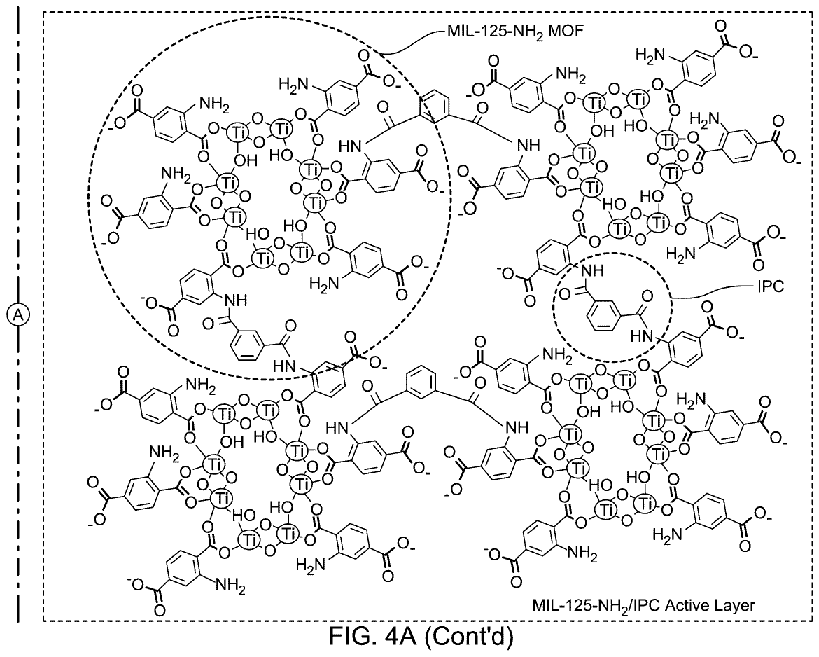

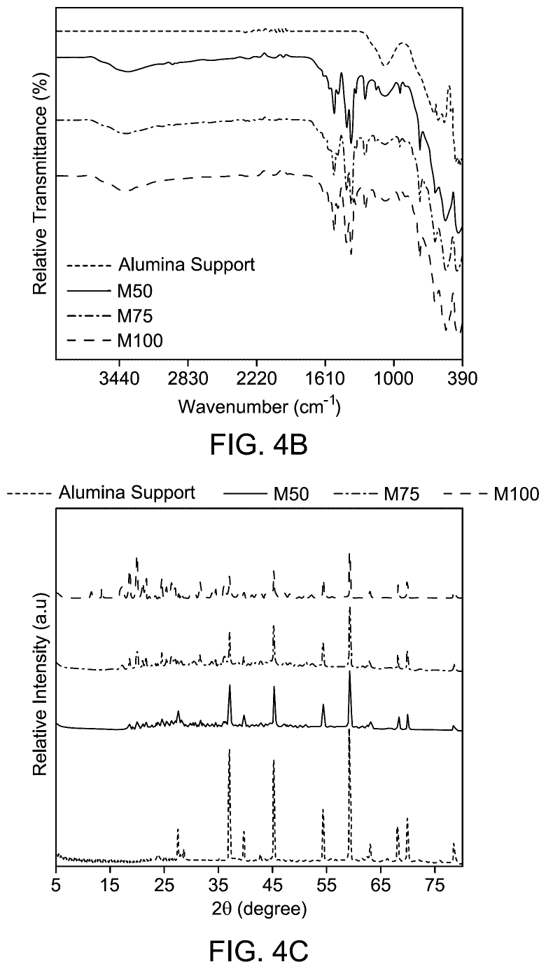

The MIL-125-NH₂ MOF, featuring amino groups in the ATPA linker, may be efficiently decorated as an active layer on the alumina ceramic support. This decoration is achieved through the Schotten-Baumann reaction, where the amino groups of MIL-125-NH₂ react with the acid chloride groups of IPC. This process facilitates the formation of a stable and functionalized active layer, enabling further analysis of the surface chemistry and crystallinity. The MIL-125-NH₂ MOF was successfully decorated on the ceramic support through stable covalent bonding between the MOF units, which is a desirable feature for membrane-based separations. FIG. 4A is a schematic representation of an interfacial polymerization reaction between the MIL-125-NH₂ MOF and isophthaloyl chloride (IPC), resulting in the formation of an active layer composed of MIL-125-NH₂ MOF/IPC on the alumina ceramic support.

FTIR spectra of alumina support, M50, M75, and M100 are shown in FIG. 4B. Characteristic peaks of the alumina support correspond to Al—O stretching at 459 cm⁻¹, 595 cm⁻¹, and 656 cm⁻¹, while a peak at 900 cm⁻¹ to 1100 cm⁻¹ was attributed to the Al—O stretching vibration due to free surface hydroxyl groups (—OH) present at the surface of the alumina support. The characteristic peaks of MOF functional groups were identified in all the MIL-125-NH₂ MOF decorated alumina nanocomposite membranes. Characteristic peaks that confirmed successful interfacial polymerization were identified at 3500 cm⁻¹ due to NH stretching vibration of an amide linkage (—CONH). A comparison of the amide peak of the MIL-125-NH₂ MOF/IPC decorated membrane and amino groups of the MIL-125-NH₂ MOF shows a difference. In the case of the MIL-125-NH₂ MOF, the peak at around 3500 cm⁻¹ appears as a doublet which is a characteristic of a primary amine. In the case of the MIL-125-NH₂ MOF ceramic membrane, the amide bond shows a broad single band. The prominent spectra indicating the asymmetric (C═O) and symmetric carbonyl (C—O) stretching vibrations at 1532 cm⁻¹ and 1378 cm⁻¹ were present, confirming the successful polymerization of the MIL-125-NH₂ MOF on the alumina substrate surface. Vibrations associated with Ti—O—Ti (774 cm⁻¹) were evident in the spectra. The intensity of the MIL-125-NH₂ MOF became more pronounced as the decoration concentration increased from 50 mg/100 mL (M50) to 100 mg/100 mL (M100).

XRD patterns of the alumina support, M50, M75, and M100 are shown in FIG. 4C. The membranes display distinct and prominently pronounced peaks corresponding to crystallographic planes of alumina, specifically (116), (024), (113), and (104), which were observed at 20 angles of 59.17°, 54.14°, 45.05°, and 36.93°, respectively. Observed peaks for the crystalline alumina align closely with those reported [Baig, U. et al., Facile fabrication of ceramic-polymeric nanocomposite membrane with special surface wettability using amino decorated NH₂—SiO₂@SiC nanopowder for production of clean water from oily wastewater, Process Saf. Environ. Prot., 2023, 171, 694-704, which is incorporated herein by reference in its entirety]. In the case of the MIL-125-NH₂ MOF decorated alumina nanocomposite membranes, new MOF crystalline peaks were seen for M50, M75, and M100. In all the nanocomposite membranes, the planes of the MIL-125-NH₂ MOF with indices (132) and (222) were observed at 2θ angles of 18.48° and 16.94°, respectively. The intensities of prominent peaks of alumina were decreased due to the covering of the alumina support by the MIL-125-NH₂ MOF. An increase in the intensities of peaks due to the MIL-125-NH₂ MOF resulted from an increase in concentration of the MIL-125-NH₂ MOF from M50 to M100. This supports the fact that the interfacial polymerization reaction led to formation of a substantial layer of the MIL-125-NH₂ MOF on the alumina ceramic support.

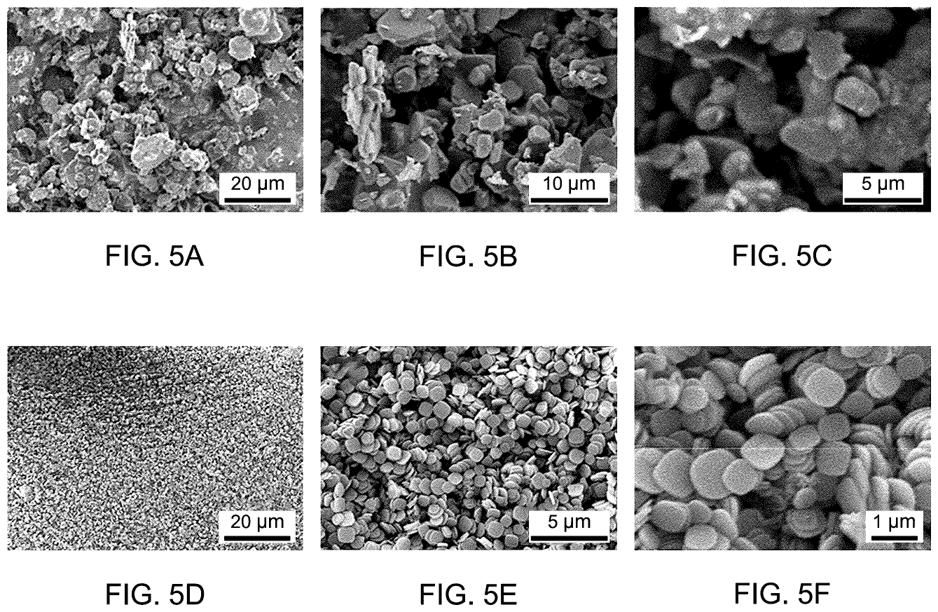

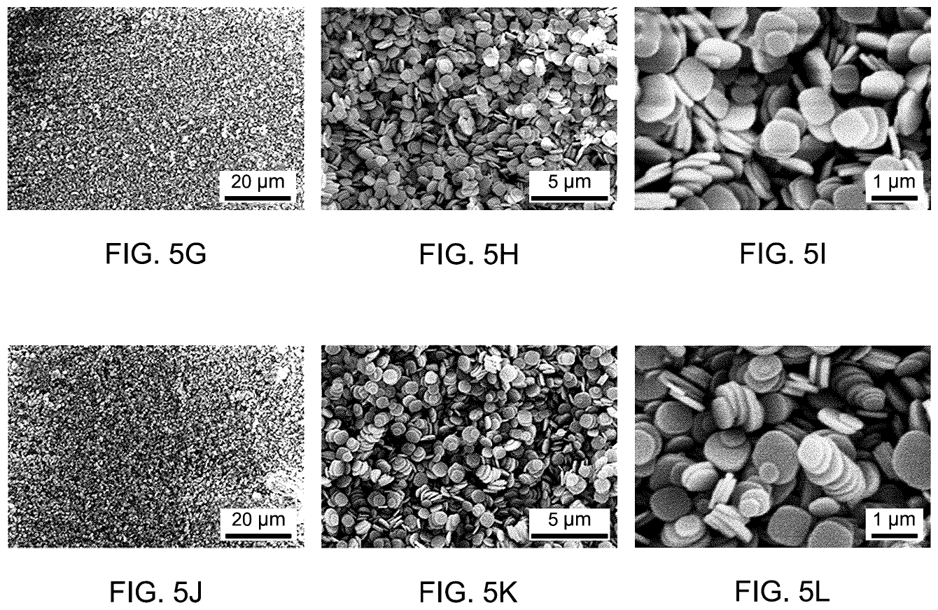

The surface morphology analysis of the alumina support, M50, M75, and M100 are shown in FIGS. 5A-5L. The alumina support exhibited a porous structure with a rough surface and irregular shaped alumina particles with a non-uniform particle size distribution, as shown in FIGS. 5A-5C. Since the alumina support was microporous, numerous micro-sized pores and voids were evident across the entire membrane area. This porous arrangement, with a size of 0.1 μm, could potentially allow the passage of oil and lead to pore clogging during the filtration process. A variation in the surface texture and morphology was observed following the successful interfacial polymerization between the MIL-125-NH₂ MOF and IPC on the alumina support. A thin layer composed of disc-shaped MIL-125-NH₂ MOF crystals with uniformly distributed pores were seen in M50, as shown in FIGS. 5D-5F, M75, as shown in FIGS. 5G-5I, and M100, as shown in FIGS. 5J-5L. Another observation which highlights the pore narrowing in M50, M75, and M100 when compared to the alumina support. The pores exhibited increased narrowing with an increased concentration of the MIL-125-NH₂ MOF. This pore constriction is a feature for rejecting the micro-sized oil droplets and allowing the water to permeate through the membranes under the applied feed pressure.

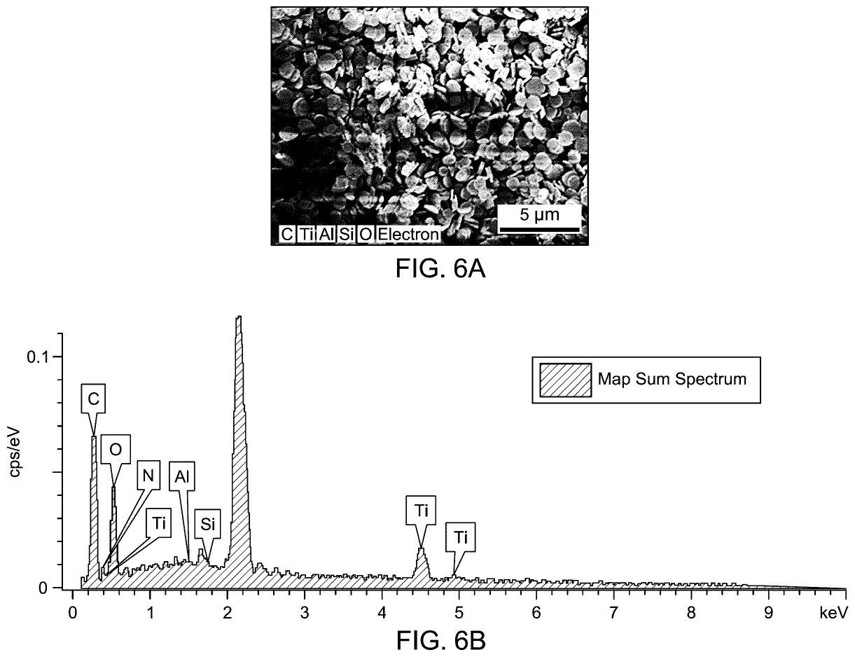

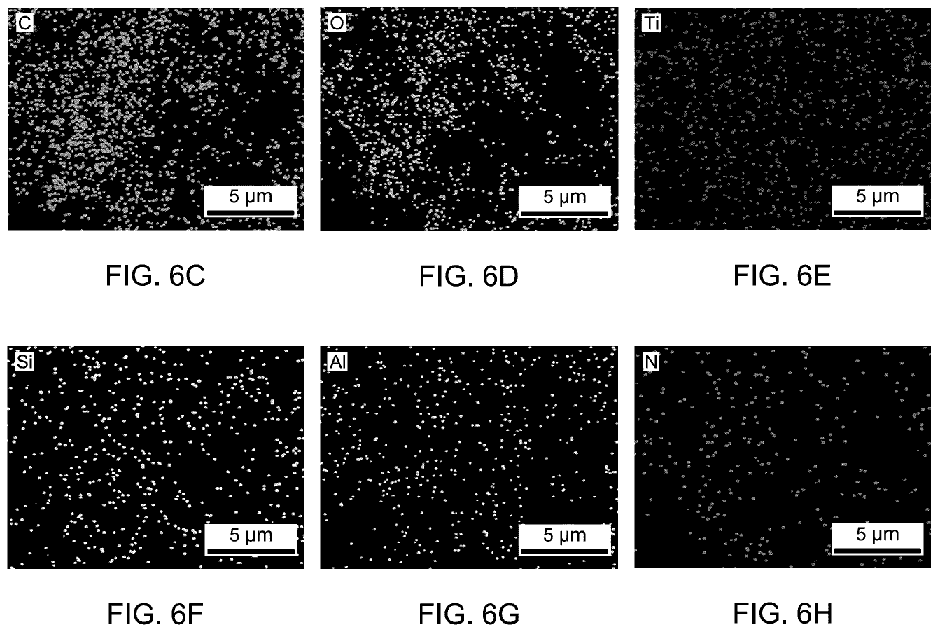

EDX and elemental mapping analysis of a representative membrane, M75, was conducted along with SEM. FIG. 6A shows an SEM-EDX map of M75 with a scale of 5 μm. EDX analysis revealed the presence elements including Ti, C, O, and N owing to the MIL-125-NH₂ MOF decorated as an active layer on ceramic alumina support, as shown in FIG. 6B. Smaller concentrations of other elements such as Al and Si were also observed, which can be attributed to the components of alumina ceramic support. The mapping analysis revealed the elements exhibited a uniform distribution as detected by EDX analysis. EDX elemental mapping images, as shown in FIGS. 6C-6H, reveal the presence of constituent elements including C, O, Ti, aluminum (Al), silicon (Si), and N, respectively. The percent concentration of each element in the MOF containing active later was reflected by the density of the mapping dots shown in their respective maps. When compared, the percentage of C, O, Ti and N was higher than that of Al and Si which confirmed the presence of the MIL-125-NH₂ MOF active layer on alumina support.

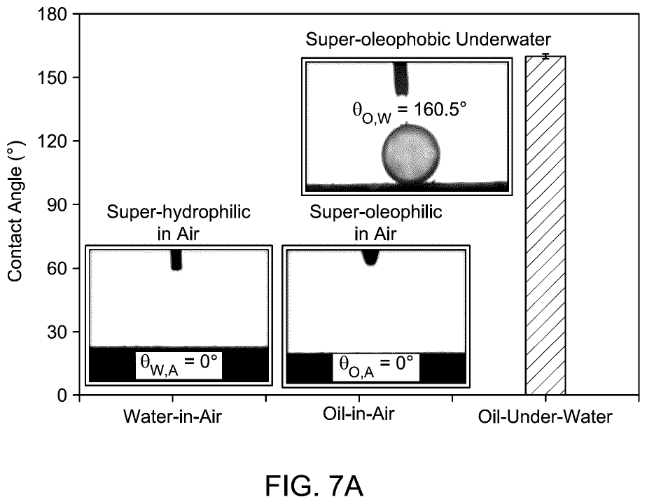

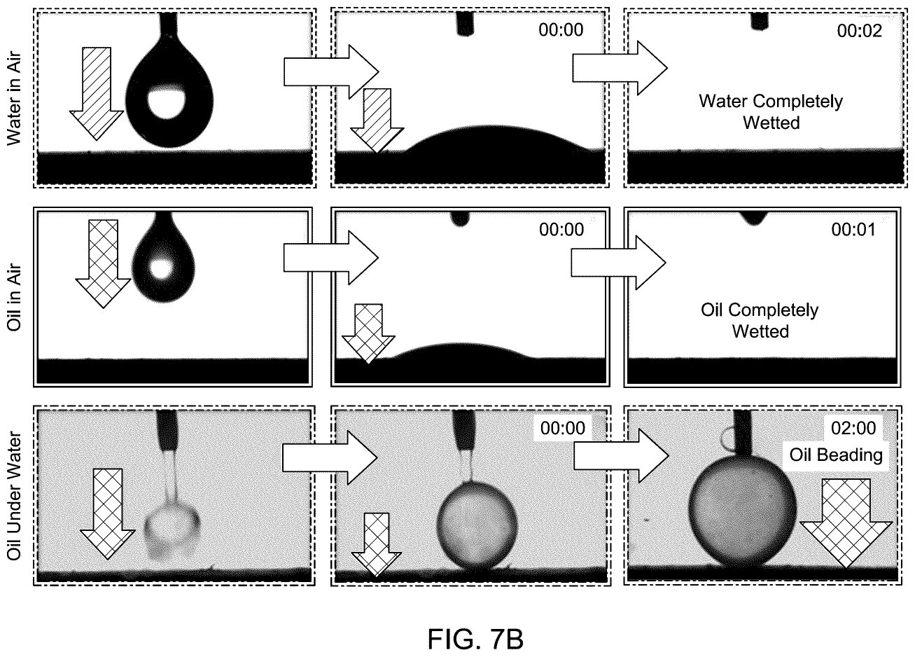

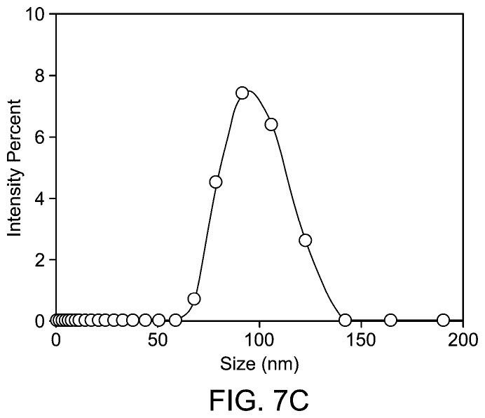

The membrane surface wettability plays a role in determining O/W emulsion separation capability. Membranes with underwater superoleophobic surfaces exhibit an ability to separate oil from water, even in the presence of surfactant-stabilized O/W emulsions. Surface contact angle analysis of M75 was conducted in different media, including water in air, oil in air, and oil under water, as shown in FIG. 7A. The water in air (θ_{W,A}) and oil in air (θ_{O,A}) contact angles were measured as 0°, demonstrating that M75 is both superhydrophilic and superoleophilic in air. This behavior may be attributed to the surface chemistry of the MIL-125-NH₂ MOF-decorated membrane (M75), which contains several hydrophilic groups, such as —COOH, NH, —CONH, and OH, along with hydrophobic moieties, like the phenyl rings of the ATPA organic linker. The hydrophilic groups interact strongly with water molecules through hydrogen bonding, while the oil is attracted by the organophilic moieties of the MOF in an air medium. Reflecting real-life filtration conditions, surface wettability was observed under water as the membrane was submerged during O/W separation experiments. A comparison of temporal contact angle measurements is shown in FIG. 7B. The membrane was fully wetted with both water and oil in air within 2 seconds and 1 second, respectively; however, for oil-under-water contact angle measurements, stable oil-beading was observed, with an underwater contact angle of 160.5° that remained consistent for up to 2 min. These findings confirmed that M75 possesses an underwater superoleophobic surface. Such surface wettability is attributed to the formation of a strong hydration layer on the M75 membrane surface, a phenomenon similarly observed with strontium-MOF [Raj, A. et al., Underwater oleophobic-super hydrophilic strontium-MOF for efficient oil/water separation, Chem. Eng. J., 2023, 453, 139757, which is incorporated herein by reference in its entirety]. This property is a beneficial feature for O/W separation, as water readily permeates through the membrane while oil is effectively rejected.

The bulk porosity (ε) of M50, M75, and M100 was determined using a well-established procedure [Guo, Z. et al., Submicro-pore containing poly(ether sulfones)/polyvinylpyrrolidone membranes for high-temperature fuel cell applications, J. Mater. Chem. A, 2015, 3, 8847-8854, which is incorporated herein by reference in its entirety]. Bulk porosities of M50, M75, and M100 was found to be 28%, 22.66%, and 21.46%, respectively.

Size distribution analysis of oil droplets in the surfactant stabilized crude oil-in-water emulsion was carried out using a Malvern Nano ZS Zetasizer, as shown in FIG. 7C. The average oil droplet size in the surfactant stabilized crude oil-in-water emulsion was approximately (~) 95 nm.

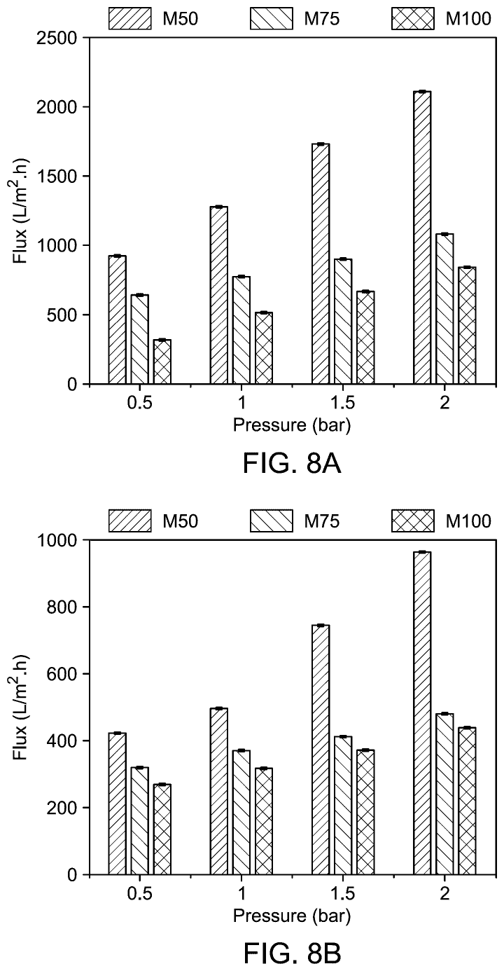

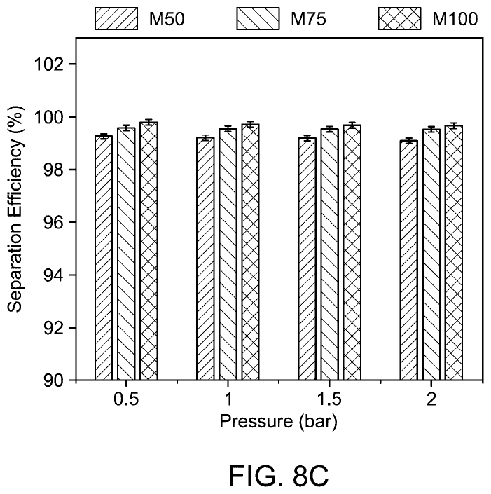

Membranes containing the MIL-125-NH₂ MOF were evaluated for water flux using deionized water as a feed in a crossflow filtration assembly. The water flux of M50, M75, and M100 as a function of increasing transmembrane pressure where the pressure was increased from 0.5 bar to 2.0 bar was recorded. A linear correlation was observed between transmembrane pressure (TMP) and water flux, as shown in FIG. 8A. This correlation suggests that the trend in flux aligns with the principles of Darcy's law. Among the fabricated membranes, M50 demonstrated the highest pure water flux of 2112 L m⁻² h⁻¹ at a transmembrane pressure of 2 bar. The high flux observed under low transmembrane pressure was attributed to the high porosity of 28% in M50, combined with enhanced hydrophilicity due to the incorporation of the MIL-125-NH₂ MOF in the active layer. The flux progressively reduced with the increasing decoration concentration of the MIL-125-NH₂ MOF. The higher concentration of decorated the MIL-125-NH₂ MOF formed a dense layer over the alumina support with interfacial polymerization, leading to porosities of 22.66% and 21.44% in M75 and M100, respectively.

O/W emulsion separation experiments of the membranes were conducted using a feed composed of an aqueous solution with 100 ppm crude oil. The oil-water flux and rejection analysis of the MIL-125-NH₂ MOF decorated alumina nanocomposite membranes M50, M75, and M100 as a function of varying transmembrane pressure is depicted in FIG. 8B. FIG. 8C is a graph depicting separation efficiency of the MIL-125-NH₂ MOF-based membranes with a 100 ppm crude oil-in-water emulsion as feed. Among the membranes, M50 displayed a flux of 963.38 L m⁻² h⁻¹ and a separation efficiency of ~99% at a transmembrane pressure of 2.0 bar. The performance of M50 may be due to the surface characteristics being super hydrophilic in air and super oleophobic under water. Since, the active layer of the membrane is composed of the MIL-125-NH₂ MOF, several hydrophilic functional groups (—CONH, —NH₂, and —COOH) can develop hydrogen bonding between the MIL-125-NH₂ MOF active layer and the water molecules yielding a strong hydration layer. The oil molecules are then pushed away from the membrane surface due low adhesive force. M75 and M100 displayed a permeate flux of 481.69 L m⁻² h⁻¹ and 439.43 L m⁻² h⁻¹ with separation efficiencies of 99.17% and 99.60%, respectively, at a transmembrane pressure of 2.0 bar. These observations may be attributed to the existence of a comparatively dense MIL-125-NH₂ MOF active layer as concentration of the MIL-125-NH₂ MOF became greater which resulted in narrowing of the pores, as also observed in SEM analysis. The membranes exhibited good rejection performance at a low transmembrane pressure of 0.5 bar. The decline in rejection was slightly mitigated under transmembrane conditions of 1.5 bar and 2.0 bar. This occurrence may be attributed to the diffusive force, leading to a flow of oil molecules across the surface.

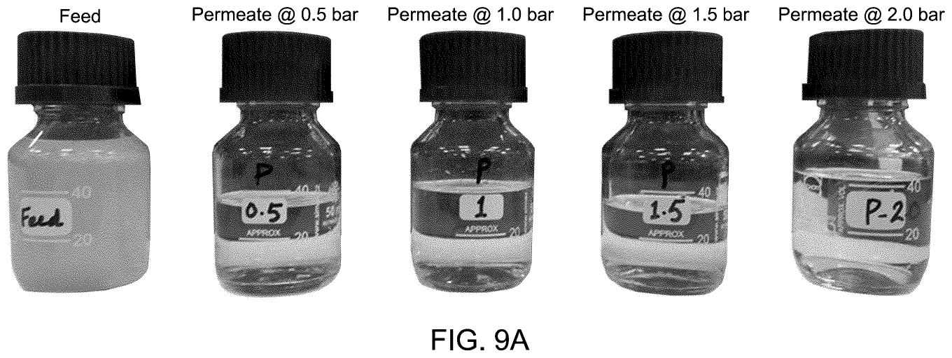

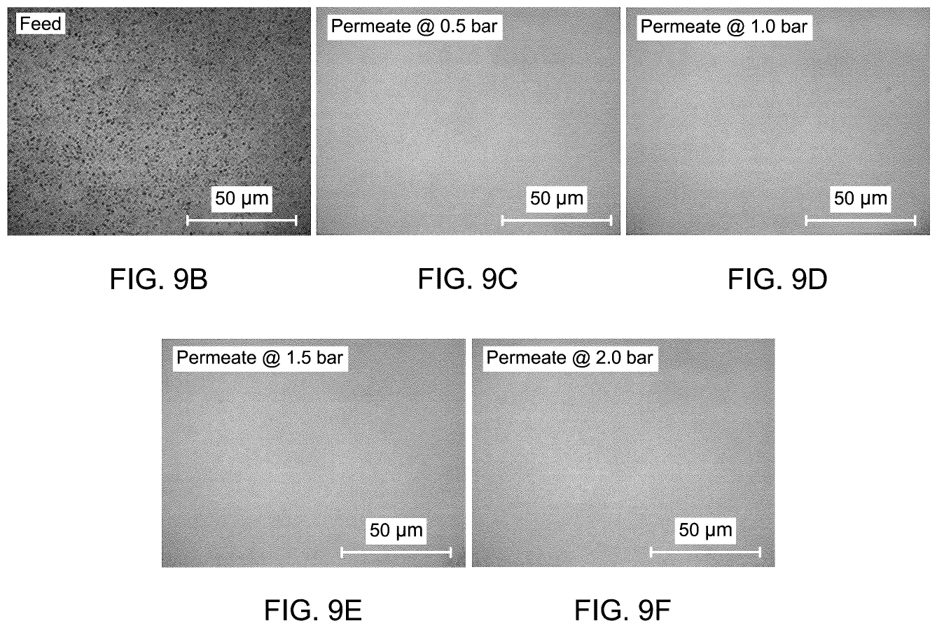

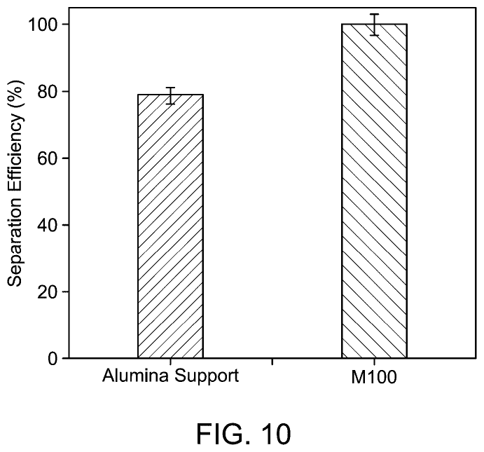

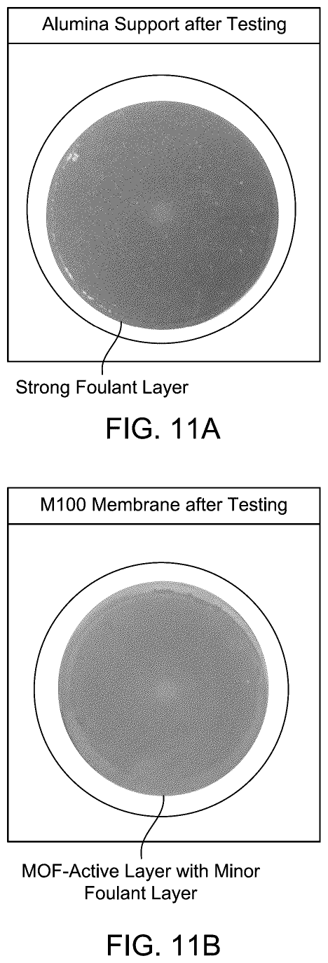

Digital and optical images of a feed sample and permeate samples collected using M100 at different TMPs are shown in FIGS. 9A-9F. FIG. 9A shows digital images of a feed sample and permeate samples including the feed, permeate collected at 0.5 bar, permeate collected 1.0 bar, permeate collected 1.5 bar, and permeate collected 2.0 bar trans-membrane pressure. FIG. 9B is an optical visualization of a feed sample with a 100-ppm crude oil-in-water emulsion. The feed appeared cloudy and milky and confirms the formation of a stable emulsion having oil droplets completely emulsified by an SDS surfactant. FIGS. 9C-9F shows an optical visualization of permeate collected at 0.5 bar, 1 bar, 1.5 bar, and 2 bar trans-membrane pressure, respectively, using M100 and a crossflow filtration system. Separation performance of the bare alumina support was also measured. FIG. 10 is a graph depicting oil-water separation efficiency of the bare alumina support and M100 (MIL-125-NH₂ MOF based membrane) using 100 ppm crude oil-in-water emulsion at 1 bar. The separation efficiency of the bare alumina support was found to be 78% which was lower compared to the MIL-125-NH₂ MOF based membranes. The separation of O/W emulsion was based on the adsorption of oil onto the surface of the alumina support. Adsorption of oil on the alumina support resulted in a decrease in the permeate flux of the alumina support. In comparison, the MOF-decorated membranes did not show any appreciable deposition of oil on the membrane surface. Digital images of the bare alumina support and M100 after testing are shown in FIGS. 11A-11B.

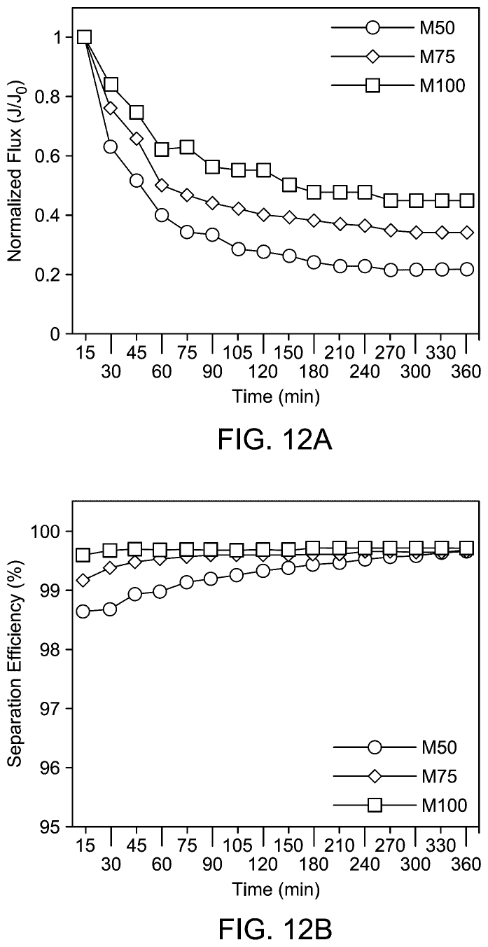

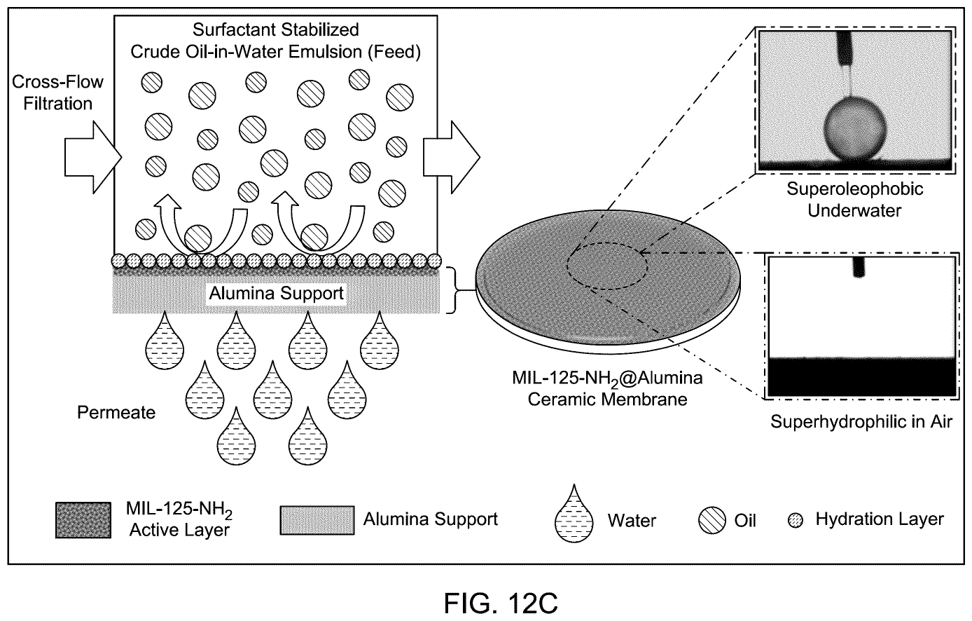

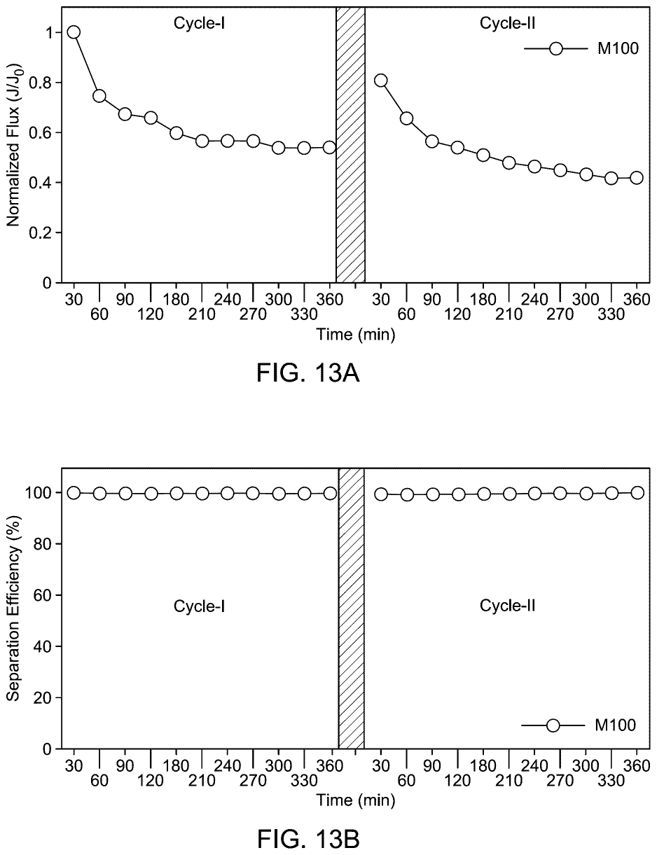

The long-term stability of the membrane was studied using 100 ppm crude oil-in-water emulsion as feed. The long-term performance of M50, M75, and M100 illustrating the variations in permeate flux and separation efficiency are shown in FIGS. 12A-12B. As depicted in FIG. 12A, the flux decreases as time progresses and reaches a steady state in nearly 100 min. The initial decline in the permeate flux may be attributed to the gradual adherence of oil droplets on the membrane surface, which eventually accumulates over time to form an oil layer. Permeate flux may rely on feed characteristics such as surfactant concentration, viscosity, and oil concentration. M100 showed a lower decline in flux rate compared to M50 and M75. Over the extended filtration period of 360 min, M100 attained a normalized flux value of 0.45, while M50 underwent a decline, dropping to as low as 0.21. The low flux drop in M100 may be attributed to the formation of a dense MIL-125-NH₂ MOF layer with a stronger hydration layer compared to M50 and M75 which restricts the accumulation of oil droplets on the membrane surface, lowering the membrane fouling. M100 exhibited a dense MIL-125-NH₂ MOF layer, as evident in the SEM analysis, as shown in FIGS. 5J-5L. The following trend of declining flux was observed as follows: M50<M75<M100, as shown in FIG. 12A. In terms of O/W emulsion separation, the separation efficiencies of the membranes gradually increased with decreasing flux which may be due to a tradeoff between flux and rejection. The membranes showed the following increasing trend of O/W emulsion separation: M50<M75<M100, as shown in FIG. 12B. The membranes underwent O/W separation for 360 min to test for stability. The membrane performance was evaluated based on flux and separation efficiency over the test duration. FIG. 13A is a normalized flux stability curve of M100. FIG. 13B is a separation efficiency stability curve of M100. The flux was decreased during the first cycle with high separation efficiency; however, upon cleaning the membrane surface with methanol for 20 min by dipping the fouled membrane in clean methanol, the membrane was able to regain performance. The cleaned membrane showed a flux recovery of 82% with an intact separation efficiency during the second cycle of performance analysis which highlighted the stability of the active layer deposited on the alumina ceramic support.

FIG. 12C is a schematic illustration of the surfactant-stabilized crude oil-in-water emulsion separation mechanism using super-hydrophilic and underwater super-oleophobic MOF-based ceramic membranes in a crossflow filtration system. Given the underwater superoleophobic nature of the membranes and the presence of hydrophilic groups, a strong hydration layer was established on the membrane surface which inhibits the formation of an oil layer on the membrane surface. The oil was not able to wet the membrane, and the oil was rejected by the membrane surface, whereas the water permeated through the membrane. An active layer of an amine-containing MOF deposited on a ceramic support by interfacial polymerization enables oil-in-water emulsion separation. The amino group enables the reaction of the MOF (MIL-125-NH₂) with acid chloride groups of an appropriate crosslinker (IPC). A stable MOF active layer may be efficiently decorated for separation applications such as O/W emulsion separation and wastewater treatment.

The membrane performance was also compared the similar membranes from literature, as listed in Table 1. The membranes prepared in the present disclosure showed a comparable performance or better performance compared to membranes known in the art. Although, the separation efficiency of membranes known in literature is ~98%, the flux of those membranes is not as high, as shown by the membranes prepared in the present disclosure. This may be attributed to the salient features of the MIL-125-NH₂ MOF like high surface area, porosity and hydrophilic pores.

TABLE 1
Membrane performance evaluation for oily-wastewater treatment

| | | | | | Permeability | | |
|---|---|---|---|---|---|---|---|
| | | Oil in | Filtration | Surface | (L m⁻² h⁻¹ | Rejection | |
| Membranes | Method | Feed | Mode | Wettability | bar¹⁾ | (%) | Ref. |
| Coal fly | Extrusion | Lubricating | Cross- | — | 222.4 | 98.5 | 1 |
| ash (CFA) | | oil | flow | | | | |
| Zwitterionic | Phase | Diesel | Cross- | Water- | 350.5 | 98.9 | 2 |
| carbon | inversion | oil | flow | 54.7° | | | |
| quantum | | | | Underwater oil- | | | |
| dots | | | | 132.3° | | | |
| (ZQDs)- | | | | | | | |
| cellulose | | | | | | | |
| acetate | | | | | | | |
| (CA) | | | | | | | |
| Zwitterionic | Co- | Soybean | Cross- | Water - | 40 | 98 | 3 |
| polydopamine/ | deposition | oil | flow | 11.81° | | | |
| polyethyleneimine | | | | Underwater oil- | | | |
| (PDA/PEI)- | | | | 150.94° | | | |
| Al₂O₃ | | | | | | | |
| pH | Phase | Crude | Cross- | Water- 0° | 420 | 98.5 | 4 |
| responsive | inversion | oil | flow | Underwater oil- | | | |
| Dimethylaminopropylamine | | | | 150° | | | |
| (DMPA)- | | | | | | | |
| polystyrene | | | | | | | |
| maleic | | | | | | | |
| anhydride/ | | | | | | | |
| Polyvinylidene | | | | | | | |
| fluoride | | | | | | | |
| (PVDF) | | | | | | | |
| M50 | Dead- | Crude | Cross- | Water-0° | 498.59 | 98.64 | This |
| M75 | end and | oil | flow | Oil -0° | 371.83 | 99.17 | Study |
| M100 | interfacial | | | Underwater Oil - | 316.90 | 99.60 | |
| | polymerization | | | 160.5° | | | |

[1] Tummons, E. et al., Membrane fouling by emulsified oil: A review, Sep. Purif. Technol., 2020, 248, 116919; [2] Huang, H. J. et al., Porous ceramic membranes from coal fly ash with addition of various pore-forming agents for oil-in-water emulsion separation, J. Environ. Chem. Eng., 2023, 11, 109929; [3] Carballo, G. V. et al., Incorporation of zwitterionic carbon quantum dots in cellulose acetate tubular membrane for oil/water separation, Sep. Purif. Technol., 2024, 126301; and [4] Luan, W. et al., Effective construction of anti-fouling zwitterion-functionalized ceramic membranes for separation of oil-in-water emulsion based on PDA/PEI co-deposition, J. Environ. Chem. Eng., 2022, 10, 108396, which are incorporated herein by references in their entireties.

MIL-125-NH₂ MOF was successfully decorated as an active layer on an alumina ceramic support through interfacial polymerization for the effective separation of a surfactant-stabilized oil-in-water emulsion. MIL-125-NH₂ characterization revealed a morphology resembling thin discs, featuring well-defined crystalline planes and the presence of hydrophilic groups. Surface morphology revealed that the thin disc-like MIL-125-NH₂ MOF layer was clearly visible on the surface of alumina ceramic support. EDX analysis confirmed the homogeneous dispersion of MOF elements on the ceramic membrane. Contact angle analysis of the MIL-125-NH₂ MOF membrane exhibited super-hydrophilic (0°) and underwater super-oleophobic (160.5°) characteristics, a beneficial feature for oil-water emulsion separation. Water flux analysis of the MIL-125-NH₂ MOF membranes showed that the flux decreased with an increase of decoration concentration of the MOF. A denser MOF layer was formed under higher concentrations of the MIL-125-NH₂ MOF for M75 and M100. In oil-water emulsion separation studies, the MIL-125-NH₂ MOF membranes showed more than 99% separation efficiency for the 100 ppm of crude oil emulsion. Long-term fouling depicted that M100 had the highest rejection with normalized flux, owed to higher decoration and concentration of the MIL-125-NH₂ MOF on the alumina support. MOF-based membranes using MIL-125-NH₂ were used for O/W emulsion separation.

Cost of the MIL-125-NH₂ MOF and the MIL-125-NH₂ MOF based membranes were also estimated. The cost for the synthesis of MIL-125-NH₂ MOF is about $3.771 (US)/g, and the total cost for the fabrication of the MIL-125-NH₂ MOF based membrane with a 47 mm diameter was about $4.4533 (US). A breakdown of the cost is listed in Table 2. Cost comparison for the fabrication of the MIL-125-NH₂ MOF based membrane with that of commercial ceramic membranes is listed in Table 3. The MIL-125-NH₂ MOF based membrane is more economical to produce than the commercial ceramic membranes listed.

TABLE 2
Cost analysis of synthesized MIL-125-NH₂ MOF and its based membrane

| S. | | Net Price | Amount | | Material cost |
|---|---|---|---|---|---|
| No. | Material | (USD) | used | | (USD) |
| 1 | Titanium isopropoxide (TTIP) | 72$/1 L | 0.6 | mL | 0.0432$ |
| 2 | 2-aminoterephthalic acid (ATPA) | 790$/1 kg | 0.56 | g | 0.442$ |
| 3 | Methanol | 20$/5 L | 7.5 | mL | 0.03$ |
| 4 | N,N-dimethyl formamide (DMF) | 90$/5 L | 62.5 | mL | 1.125$ |
| 5 | Washing, filtration, drying and | 1$/reaction | 1 | | 1$ |
| | other cost | | | | |

Total cost of MIL-125-NH₂ MOF: 2.6402$/700 mg, and 3.771$/g

| | | | | | |
|---|---|---|---|---|---|
| 6 | IPC (IPC) | 84$/1 kg | 0.075 | g | 0.0063$ |
| 7 | n-Hexane | 72$/5 L | 50 | mL | 0.72$ |

| | | | | |
|---|---|---|---|---|
| 8 | Alumina ceramic disc | 2.35$/Disc | 1 | 2.35$ |
| 9 | Washing, filtration, drying and | 1$/Disc | 1 | 1$ |
| | other cost | | | |

Total cost of MIL-125-NH₂ MOF based membrane:
4.4533$/membrane disc having 47 mm diameter.

TABLE 3
Comparison of total cost (USD/Disc) of commercially
available ceramic membranes

| | | Diameter | Pack | | Price of | Price of |
|---|---|---|---|---|---|---|
| SKU | Product Name | (mm) | Size | Designation | 5 Discs | 1 Disc |
| 47U300 | TAMI Ceramic | 47 | 5 | Ultrafiltration | $268.00 | $53.6 |
| | Membrane, 300 | | | | | |
| | KD, 47 mm, 5/Pk | | | | | |
| 47U150 | TAMI Ceramic | 47 | 5 | Ultrafiltration | $268.00 | $53.6 |
| | Membrane, 150 | | | | | |
| | KD, 47 mm, 5/Pk | | | | | |
| 47U050 | TAMI Ceramic | 47 | 5 | Ultrafiltration | $268.00 | $53.6 |
| | Membrane, 50 | | | | | |
| | KD, 47 mm, 5/Pk | | | | | |
| 47U015 | TAMI Ceramic | 47 | 5 | Ultrafiltration | $268.00 | $53.6 |
| | Membrane, 15 | | | | | |
| | KD, 47 mm, 5/Pk | | | | | |

Source: Sterlitech Corporation

Ceramic membranes offer potential for addressing challenging and harsh wastewater streams, such as produced water (PW) and surfactant-stabilized O/W emulsions. A membrane comprising an active layer solely composed of MIL-125-NH₂ MOF on a ceramic alumina support is developed. A covalent bonding approach was employed using interfacial polymerization, with IPC acting as the organic crosslinker during interfacial polymerization. Three MIL-125-NH₂ MOF decorated membranes (M50, M75, and M100) were prepared using varying MIL-125-NH₂ MOF concentrations. Surface wettability analysis of the membranes indicated that the MIL-125-NH₂ MOF active layer displayed super-hydrophilic characteristics in the air (water contact angle=0°) and super-oleophobic characteristics underwater (oil contact angle=160.5°). In oil separation experiments, the MIL-125-NH₂ MOF decorated membranes displayed >99% oil rejection. M50 demonstrated the highest pure water flux of about 2100 L m⁻² h⁻¹ under a transmembrane pressure of 2 bar. The MIL-125-NH₂ MOF deposited membranes also showed stable performance under long-run filtration. MIL-125-NH₂ MOFs as an active layer on ceramic alumina support are efficient O/W emulsion separation and desalination materials.

Numerous modifications and variations of the present disclosure are possible in light of the above teachings. Therefore, it is to be understood that within the scope of the appended claims, the disclosure may be practiced other than as specifically described herein.

1: A membrane, comprising:
a first layer comprising a ceramic alumina support; and
a second layer comprising particles of a MIL-125-NH₂ metal-organic framework crosslinked with isophthaloyl units,
wherein one or more amine groups of the MIL-125-NH₂ metal-organic framework is covalently bonded to one or more acid groups of the isophthaloyl units,
wherein the membrane is porous with a pore size of 0.01 to 0.2 μm,
wherein the particles of the second layer are in the shape of discs having a longest dimension of 0.5 to 3 μm.

2: The membrane of claim 1, wherein the membrane has a water in air contact angle of 0°.

3: The membrane of claim 1, wherein the membrane has an oil in air contact angle of 0°.

4: The membrane of claim 1, wherein the membrane has an oil in water contact angle of 155 to 165°.

5: The membrane of claim 1, wherein the MIL-125-NH₂ metal-organic framework has an average particle size of 0.5 to 0.9 μm.

6: The membrane of claim 1, wherein the MIL-125-NH₂ metal-organic framework has a Brunauer-Emmett-Teller surface area of 900 to 1000 m²/g.

7: The membrane of claim 1, wherein the MIL-125-NH₂ metal-organic framework is porous and has a micropore surface area of 700 to 750 m²/g and a micropore volume of 0.25 to 0.3 cm²/g.

8: The membrane of claim 1, wherein the MIL-125-NH₂ metal-organic framework is porous and has a pore width of 0.88 to 0.9 nm and an average pore diameter of 1.5 to 2 nm.

9: The membrane of claim 1, wherein covalent bonds between the one or more amine groups of the MIL-125-NH₂ metal-organic framework and the one or more acid groups of the isophthaloyl units are formed through interfacial polymerization.

10: The membrane of claim 1, wherein the particles in the second layer are stacked and agglomerated having an average stacked height of 0.2 to 4 μm.

11: The membrane of claim 1, wherein the membrane has a water permeability of distilled water of 500 to 1400 L m⁻² h⁻¹ bar⁻¹ at a pressure of 1 bar.

12: The membrane of claim 1, wherein the membrane has a water permeability from an oil-in-water emulsion of 300 to 500 L m⁻² h⁻¹ bar⁻¹ at a pressure of 1 bar.

13: The membrane of claim 1, wherein the membrane has a bulk porosity of 20 to 30% based on a volume of voids in the membrane over the total volume of the membrane.

14: A method of oil separation, comprising:
contacting the membrane of claim 1 with an oily mixture comprising one or more oils and water,
collecting a filtrate,
wherein the filtrate comprises a lesser amount of the one or more oils in comparison to the amount of the one or more oils in the oily mixture.

15: The method of claim 14, wherein the membrane has a separation efficiency of at least 98% based on an initial amount of the one or more oils in the oily mixture.

16: The method of claim 14, further comprising:
applying a transmembrane pressure of 0.1 to 3 bar after the contacting.

17: The method of claim 14, wherein the oily mixture comprises a surfactant.

18: The method of claim 14, further comprising:
cleaning the membrane; then
repeating contacting the membrane with an oily mixture 2 to 5 times; and
collecting a filtrate,
wherein the membrane has a separation efficiency of at least 98% of that of an initial separation efficiency.

19: The membrane of claim 1, wherein the membrane is made by a process comprising:
mixing titanium isopropoxide and 2-aminoterephthalic acid in dimethylformamide and methanol to form a solution;
heating the solution at a temperature of 130 to 170° C. for 20 to 28 hours to form a solid;
calcinating the solid at a temperature of 180 to 220° C. for 4 to 8 hours to form the MIL-125-NH₂ metal-organic framework;
dispersing the MIL-125-NH₂ metal-organic framework in water to form a mixture;
depositing the mixture on the ceramic alumina support;
drying the mixture on the ceramic alumina support;
dipping the dried mixture on the ceramic alumina support in an n-hexane solution of isophthaloyl chloride to form a pre-membrane; and
curing the pre-membrane at a temperature of 50 to 90° C. for 0.5 to 2 hours to form the membrane.

20: The membrane of claim 19, wherein an amount of the MIL-125-NH₂ metal-organic framework in water to form the mixture is from 30 to 120 mg of the MIL-125-NH₂ metal-organic framework in 100 mL water.
